(19) United States
(12) Patent Application Publication
(10) Pub. No.: US 2026/0188190 A1
(43) Pub. Date: Jul. 2, 2026

(54) DRIVER, DISPLAY APPARATUS INCLUDING THE SAME AND ELECTRONIC APPARATUS INCLUDING THE SAME

(71) Applicant: Samsung Display Co., Ltd., Yongin-si (KR)

(72) Inventors: Minjae JEONG, Yongin-si (KR); Ilnam KIM, Yongin-si (KR); Minkyu WOO, Yongin-si (KR); Jaeyoung JANG, Yongin-si (KR); Jaehyung CHO, Yongin-si (KR)

(73) Assignee: Samsung Display Co., Ltd., Yongin-si (KR)

(21) Appl. No.: 19/335,491

(22) Filed: Sep. 22, 2025

(30) Foreign Application Priority Data
Jan. 2, 2025 (KR) 10-2025-0000245

(51) Int. Cl. G09G 3/32

(52) U.S. Cl. CPC G09G 3/32; G09G 2310/0267; G09G 2310/0275; G09G 2310/0289; G09G 2310/08; G09G 2330/021

(57) ABSTRACT

A driver includes a stage including an input circuit transmitting a previous carry signal to a first control node in response to a first clock signal and a second clock signal having different phases, a carry output circuit generating a present carry signal based on a first high power voltage and a low power voltage in response to a signal of the first control node, a level shifter generating a signal of a second control node and a signal of a third control node in response to a second high power voltage greater than the first high power voltage and the low power voltage and an output circuit generating an output signal based on the second high power voltage and the low power voltage in response to the signal of the second control node or the signal of the third control node.

### CROSS-REFERENCE TO RELATED APPLICATION(S)

This application claims priority under 35 U.S.C. § 119 to Korean Patent Application No. 10-2025-0000245, filed on Jan. 2, 2025 in the Korean Intellectual Property Office, the disclosure of which is herein incorporated by reference herein in its entireties.

### BACKGROUND

### 1. Field

Embodiments of the disclosure relate to a driver, a display apparatus including the driver and an electronic apparatus including the driver. More particularly, embodiments of the disclosure relate to a CMOS (complementary metal oxide semiconductor) type driver used as a gate driver or an emission driver, a display apparatus including the driver, and an electronic apparatus including the driver.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver may output gate signals to the gate lines. The data driver may output data voltages to the data lines. The emission driver may output emission signals to the emission lines. The driving controller controls the gate driver, the data driver and the emission driver.

A driver (e.g., the gate driver and/or the emission driver) of the display apparatus may sequentially output signals (e.g., the gate signals and/or the emission signals) to the pixels of the display panel in units of pixels rows. The driver may be implemented in a form of a shift register including a plurality of stages to sequentially output the signals in units of the pixel rows.

When a clock signal, a carry signal and an output signal are generated based on the same power voltage, a power consumption of the display apparatus may be high.

### SUMMARY

Embodiments of the disclosure provide a driver including a level shifter to set swing ranges of a clock signal and a carry signal to be less than a swing range of an output signal, thereby reducing power consumption.

Embodiments of the disclosure also provide a display apparatus including the driver.

Embodiments of the disclosure also provide an electronic apparatus including the driver.

In an embodiment, a driver including a stage which includes an input circuit, a carry output circuit, a level shifter and an output circuit. The input circuit may be configured to transmit a previous carry signal to a first control node in response to a first clock signal and a second clock signal having a phase different from a phase of the first clock signal. The carry output circuit may be configured to generate a present carry signal based on a first high power voltage and a low power voltage in response to a signal of the first control node. The level shifter may be configured to generate a signal of a second control node and a signal of a third control node in response to a second high power voltage, which is greater than the first high power voltage, and the low power voltage. The output circuit may be configured to generate an output signal based on the second high power voltage and the low power voltage in response to the signal of the second control node or the signal of the third control node.

In an embodiment, the driver may include a plurality of the stages comprising at least one odd-numbered stage and at least one even-numbered stage connected in series, based on the stage being an odd-numbered stage among the plurality of the stages connected in series, the output circuit may be configured to output the output signal in response to the signal of the second control node. Based on the stage being an even-numbered stage, the output circuit may be configured to output the output signal in response to the signal of the third control node.

In an embodiment, based on the stage being the odd-numbered stage, a phase of the present carry signal may be opposite to a phase of the output signal. Based on the stage being the even-numbered stage, a phase of the present carry signal may be substantially the same as a phase of the output signal.

In an embodiment, based on the stage being the odd-numbered stage, a phase of the signal of the first control node may be substantially the same as the phase of the output signal. Based on the stage being the even-numbered stage, a phase of the signal of the first control node may be opposite to the phase of the output signal.

In an embodiment, each of a high level of the previous carry signal, a high level of the present carry signal, a high level of the first clock signal, a high level of the second clock signal may be the first high power voltage, and each of a low level of the previous carry signal, a low level of the present carry signal, a low level of the first clock signal, a low level of the second clock signal may be the low power voltage.

In an embodiment, each of a high level of the signal of the first control node may be the first high power voltage, and each of a low level of the signal of the first control node may be the low power voltage.

In an embodiment, a high level of the signal of the second control node and a high level of the signal of the third control node may be the second high power voltage and a low level of the signal of the second control node and a low level of the signal of the third control node may be the low power voltage.

In an embodiment, the input circuit may include a first transistor including a control electrode configured to receive the first clock signal, a first electrode configured to receive the previous carry signal and a second electrode connected to the first control node and a second transistor including a control electrode configured to receive the second clock signal, a first electrode configured to receive the previous carry signal and a second electrode connected to the first control node.

In an embodiment, the carry output circuit may include a first transistor including a control electrode connected to the first control node, a first electrode configured to receive the first high power voltage and a second electrode connected to a carry output node and a second transistor including a control electrode connected to the first control node, a first electrode configured to receive the low power voltage and a second electrode connected to the carry output node.

In an embodiment, the carry output circuit may further include a capacitor including a first electrode configured to receive the first high power voltage and a second electrode connected to the first control node.

In an embodiment, the carry output circuit may further include a capacitor including a first electrode configured to receive the second high power voltage and a second electrode connected to the first control node.

In an embodiment, the carry output circuit may further include a capacitor including a first electrode configured to receive the low power voltage and a second electrode connected to the first control node.

In an embodiment, the level shifter may include a first transistor including a control electrode connected to the second control node, a first electrode configured to receive the second high power voltage and a second electrode connected to a first intermediate node, a second transistor including a control electrode connected to the carry output node, a first electrode connected to the first intermediate node and a second electrode connected to the third control node, a third transistor including a control electrode connected to the carry output node, a first electrode configured to receive the low power voltage and a second electrode connected to the third control node, a fourth transistor including a control electrode connected to the third control node, a first electrode configured to receive the second high power voltage and a second electrode connected to a second intermediate node, a fifth transistor including a control electrode connected to the first control node, a first electrode connected to the second intermediate node and a second electrode connected to the second control node and a sixth transistor including a control electrode connected to the first control node, a first electrode configured to receive the low power voltage and a second electrode connected to the second control node.

In an embodiment, the output circuit may include a seventh transistor including a control electrode connected to the second control node, a first electrode configured to receive the second high power voltage and a second electrode connected to an output node and an eighth transistor including a control electrode connected to the second control node, a first electrode configured to receive the low power voltage and a second electrode connected to the output node.

In an embodiment, the output circuit may include a seventh transistor including a control electrode connected to the third control node, a first electrode configured to receive the second high power voltage and a second electrode connected to an output node and an eighth transistor including a control electrode connected to the third control node, a first electrode configured to receive the low power voltage and a second electrode connected to the output node.

In an embodiment, based on the stage being an odd-numbered stage, the odd-numbered stage may include a first transistor including a control electrode configured to receive the first clock signal, a first electrode configured to receive the previous carry signal and a second electrode connected to the first control node, a second transistor including a control electrode configured to receive the second clock signal, a first electrode configured to receive the previous carry signal and a second electrode connected to the first control node, a third transistor including a control electrode connected to the first control node, a first electrode configured to receive the first high power voltage and a second electrode connected to a carry output node, a fourth transistor including a control electrode connected to the first control node, a first electrode configured to receive the low power voltage and a second electrode connected to the carry output node, a fifth transistor including a control electrode connected to the second control node, a first electrode configured to receive the second high power voltage and a second electrode connected to a first intermediate node, a sixth transistor including a control electrode connected to the carry output node, a first electrode connected to the first intermediate node and a second electrode connected to the third control node, a seventh transistor including a control electrode connected to the carry output node, a first electrode configured to receive the low power voltage and a second electrode connected to the third control node, an eighth transistor including a control electrode connected to the third control node, a first electrode configured to receive the second high power voltage and a second electrode connected to a second intermediate node, a ninth transistor including a control electrode connected to the first control node, a first electrode connected to the second intermediate node and a second electrode connected to the second control node, a tenth transistor including a control electrode connected to the first control node, a first electrode configured to receive the low power voltage and a second electrode connected to the second control node, an eleventh transistor including a control electrode connected to the second control node, a first electrode configured to receive the second high power voltage and a second electrode connected to an output node and a twelfth transistor including a control electrode connected to the second control node, a first electrode configured to receive the low power voltage and a second electrode connected to the output node. The first transistor, the third transistor, the fifth transistor, the sixth transistor, the eighth transistor, the ninth transistor and the eleventh transistor of the odd-numbered stage may be P-type transistors, respectively. The second transistor, the fourth transistor, the seventh transistor, the tenth transistor and the twelfth transistor of the odd-numbered stage may be N-type transistors, respectively.

In an embodiment, based on the stage being an even-numbered stage, the even-numbered stage may include a first transistor including a control electrode configured to receive the second clock signal, a first electrode configured to receive the previous carry signal and a second electrode connected to the first control node, a second transistor including a control electrode configured to receive the first clock signal, a first electrode configured to receive the previous carry signal and a second electrode connected to the first control node, a third transistor including a control electrode connected to the first control node, a first electrode configured to receive the first high power voltage and a second electrode connected to a carry output node, a fourth transistor including a control electrode connected to the first control node, a first electrode configured to receive the low power voltage and a second electrode connected to the carry output node, a fifth transistor including a control electrode connected to the second control node, a first electrode configured to receive the second high power voltage and a second electrode connected to a first intermediate node, a sixth transistor including a control electrode connected to the carry output node, a first electrode connected to the first intermediate node and a second electrode connected to the third control node, a seventh transistor including a control electrode connected to the carry output node, a first electrode configured to receive the low power voltage and a second electrode connected to the third control node, an eighth transistor including a control electrode connected to the third control node, a first electrode configured to receive the second high power voltage and a second electrode connected to a second intermediate node, a ninth transistor including a control electrode connected to the first control node, a first electrode connected to the second intermediate node and a second electrode connected to the second control node, a tenth transistor including a control electrode connected to the first control node, a first electrode configured to receive the low power voltage and a second electrode connected to the second control node, an eleventh transistor including a control electrode connected to the third control node, a first electrode configured to receive the second high power voltage and a second electrode connected to an output node and a twelfth transistor including a control electrode connected to the third control node, a first electrode configured to receive the low power voltage and a second electrode connected to the output node. The first transistor, the third transistor, the fifth transistor, the sixth transistor, the eighth transistor, the ninth transistor and the eleventh transistor of the even-numbered stage may be P-type transistors, respectively. The second transistor, the fourth transistor, the seventh transistor, the tenth transistor and the twelfth transistor of the even-numbered stage may be N-type transistors, respectively.

In an embodiment of a display apparatus according to the disclosure, the display apparatus may include a display panel, a gate driver, a data driver and an emission driver. The display panel may include a pixel. The gate driver may be configured to output a gate signal to the pixel. The data driver may be configured to output a data voltage to the pixel. The emission driver may be configured to output an emission signal to the pixel. The gate driver may include at least one stage. The at least one stage of the gate driver may include an input circuit, a carry output circuit, a level shifter and an output circuit. The input circuit may be configured to transmit a previous carry signal to a first control node in response to a first clock signal and a second clock signal having a phase different from a phase of the first clock signal. The carry output circuit may be configured to generate a present carry signal based on a first high power voltage and a low power voltage in response to a signal of the first control node. The level shifter may be configured to generate a signal of a second control node and a signal of a third control node in response to a second high power voltage, which is greater than the first high power voltage, and the low power voltage. The output circuit may be configured to generate an output signal based on the second high power voltage and the low power voltage in response to the signal of the second control node or the signal of the third control node.

In an embodiment, a display apparatus may include a display panel, a gate driver, a data driver and an emission driver. The display panel may include a pixel. The gate driver may be configured to output a gate signal to the pixel. The data driver may be configured to output a data voltage to the pixel. The emission driver may be configured to output an emission signal to the pixel. The emission driver may include at least one stage. The at least one stage of the emission driver may include an input circuit, a carry output circuit, a level shifter and an output circuit. The input circuit may be configured to transmit a previous carry signal to a first control node in response to a first clock signal and a second clock signal having a phase different from a phase of the first clock signal. The carry output circuit may be configured to generate a present carry signal based on a first high power voltage and a low power voltage in response to a signal of the first control node. The level shifter may be configured to generate a signal of a second control node and a signal of a third control node in response to a second high power voltage, which is greater than the first high power voltage, and the low power voltage. The output circuit may be configured to generate an output signal based on the second high power voltage and the low power voltage in response to the signal of the second control node or the signal of the third control node.

In an embodiment, an electronic apparatus may include a display panel, a gate driver, a data driver, an emission driver, a driving controller and a processor. The display panel may include a pixel. The gate driver may be configured to output a gate signal to the pixel. The data driver may be configured to output a data voltage to the pixel. The emission driver may be configured to output an emission signal to the pixel. The driving controller may be configured to control the gate driver, the data driver and the emission driver. The processor may be configured to output input image data and an input control signal to the driving controller. The gate driver or the emission driver may comprise at least one stage. The at least one stage of the gate driver or the at least one stage of the emission driver may include an input circuit, a carry output circuit, a level shifter and an output circuit. The input circuit may be configured to transmit a previous carry signal to a first control node in response to a first clock signal and a second clock signal having a phase different from a phase of the first clock signal. The carry output circuit may be configured to generate a present carry signal based on a first high power voltage and a low power voltage in response to a signal of the first control node. The level shifter may be configured to generate a signal of a second control node and a signal of a third control node in response to a second high power voltage, which is greater than the first high power voltage, and the low power voltage. The output circuit may be configured to generate an output signal based on the second high power voltage and the low power voltage in response to the signal of the second control node or the signal of the third control node.

In an embodiment, a driver may include a first stage and a second stage connected in series, each of the first and second stages including: an input circuit configured to transmit a previous carry signal to a first control node in response to a clock signal; a carry output circuit configured to generate a present carry signal based on a first high power voltage and a low power voltage in response to a signal of the first control node; a level shifter configured to generate a signal of a second control node and a signal of a third control node in response to a second high power voltage, which is greater than the first high power voltage, and the low power voltage; and an output circuit configured to generate an output signal based on the second high power voltage and the low power voltage, wherein the output circuit of the first stage may be configured to generate the output signal in response to the signal of the second control node, wherein the input circuit of the second stage may be configured to receive the present carry signal of the first stage, and wherein the output circuit of the second stage may be configured to generate the output signal in response to the signal of the third control node.

In an embodiment, a driver may include: an input circuit configured to transmit an input carry signal to a first control node in response to a clock signal; a carry output circuit configured to generate an output carry signal based on a first high power voltage and a low power voltage in response to a signal of the first control node such that the output carry signal has a first swing range between the first high power voltage and the low power voltage; a level shifter configured to generate a signal of a second control node and a signal of a third control node in response to a second high power voltage, which is greater than the first high power voltage, and the low power voltage, such that the signal of the second control node and the signal of the third control node each have a second swing range between the first high power voltage and the low power voltage, the second swing range being greater than the first swing range; and an output circuit configured to generate an output signal based on the second high power voltage and the low power voltage in response to the signal of the second control node or the signal of the third control node such that the output signal has the second swing range.

According to the driver, the display apparatus including the driver and the electronic apparatus including the driver, the driver may include the level shifter so that the clock signal and the carry signal may swing (or oscillate) between the first high power voltage and the low power voltage and the output signal may swing (or oscillate) between the second high power voltage, which is higher than the first high power voltage, and the low power voltage.

The swing range of the clock signal and the carry signal of the driver may be reduced so that the power consumption of the display apparatus may be reduced.

### BRIEF DESCRIPTION OF DRAWINGS

The above and other features and advantages of the disclosure will become more apparent by describing in detailed embodiments thereof with reference to the accompanying drawings, in which:

FIG. 1 is a block diagram illustrating a display apparatus according to an embodiment of the disclosure;

FIG. 2A is a block diagram illustrating a gate driver of FIG. 1;

FIG. 2B is a block diagram illustrating an emission driver of FIG. 1;

FIG. 3 is a timing diagram illustrating an example of an operation of the driver of FIG. 2A and FIG. 2B;

FIG. 4 is a circuit diagram illustrating an odd-numbered stage of the driver of FIG. 2A and FIG. 2B;

FIG. 5 is a circuit diagram illustrating an even-numbered stage of the driver of FIG. 2A and FIG. 2B;

FIG. 6 is a timing diagram illustrating an example of an operation of the stage of FIG. 4 and FIG. 5;

FIG. 7 is a circuit diagram illustrating an example of an operation of the stage of FIG. 4 in a second period of FIG. 6;

FIG. 8 is a circuit diagram illustrating an example of an operation of the stage of FIG. 4 in the second period of FIG. 6;

FIG. 9 is a circuit diagram illustrating an example of an operation of the stage of FIG. 4 in an eighth period of FIG. 6;

FIG. 10 is a circuit diagram illustrating an example of an operation of the stage of FIG. 4 in the eighth period of FIG. 6;

FIG. 11 is a circuit diagram illustrating an example of an operation of the stage of FIG. 5 in a third period of FIG. 6;

FIG. 12 is a circuit diagram illustrating an example of an operation of the stage of FIG. 5 in the third period of FIG. 6;

FIG. 13 is a circuit diagram illustrating an example of an operation of the stage of FIG. 5 in a ninth period of FIG. 6;

FIG. 14 is a circuit diagram illustrating an example of an operation of the stage of FIG. 5 in the ninth period of FIG. 6;

FIG. 15 is a circuit diagram illustrating an example of a pixel of a display panel of FIG. 1;

FIG. 16 is a timing diagram illustrating an example of input signals of a pixel of FIG. 15;

FIG. 17 is a circuit diagram illustrating an odd-numbered stage of a driver of a display apparatus according to an embodiment of the disclosure;

FIG. 18 is a circuit diagram illustrating an odd-numbered stage of a driver of a display apparatus according to an embodiment of the disclosure;

FIG. 19 is a circuit diagram illustrating an odd-numbered stage of a driver of a display apparatus according to an embodiment of the disclosure;

FIG. 20 is a block diagram illustrating an electronic apparatus according to an embodiment of the disclosure;

FIG. 21 is a diagram illustrating an example in which the electronic apparatus of FIG. 20 is implemented as a smartphone;

FIG. 22 is a block diagram illustrating an electronic apparatus according to an embodiment of the disclosure; and

FIG. 23 is schematic diagrams illustrating the electronic apparatuses of FIG. 22.

### DETAILED DESCRIPTION

In the specification, it will be understood that when an element (or region, layer, part, etc.) is referred to as being “on”, “connected to”, or “coupled to” another element, it can be directly on, connected to, or coupled to the other element, or one or more intervening elements may be present therebetween. In a similar sense, when an element (or region, layer, part, etc.) is described as “covering” another element, it can directly cover the other element, or one or more intervening elements may be present therebetween.

In the specification, when an element is “directly on,” “directly connected to,” or “directly coupled to” another element, there are no intervening elements present. For example, “directly on” may mean that two layers or two elements are disposed without an additional element such as an adhesion element therebetween.

As used herein, the expressions used in the singular such as “a,” “an,” and “the,” are intended to include the plural forms as well, unless the context clearly indicates otherwise.

As used herein, the term “and/or” includes any and all combinations of one or more of the associated listed items. For example, “A and/or B” may be understood to mean “A, B, or A and B.” The terms “and” and “or” may be used in the conjunctive or disjunctive sense and may be understood to be equivalent to “and/or”.

As used herein, an expression “at least one of” preceding a list of elements modifies the entire list of the elements and does not modify the individual elements of the list. For example, “at least one of A, B, and C” may be understood to mean A only, B only, C only, or any combination of two or more of A, B, and C. It is also to be understood that the terms substantially” as used herein with regard to thicknesses, widths, percentages, ranges, signal phases, etc., are meant to denote being close or approximate to, but not exactly. For example, the term “substantially” as used herein implies that a small margin of error may be present, such as 5 % or less than the stated amount.

It will be understood that, although the terms first, second, etc. may be used herein to describe various elements, these elements should not be limited by these terms. These terms are only used to distinguish one element from another element. Thus, a first element could be termed a second element without departing from the teachings of the disclosure. Similarly, a second element could be termed a first element, without departing from the scope of the disclosure.

Hereinafter, the disclosure will be explained in detail with reference to the accompanying drawings.

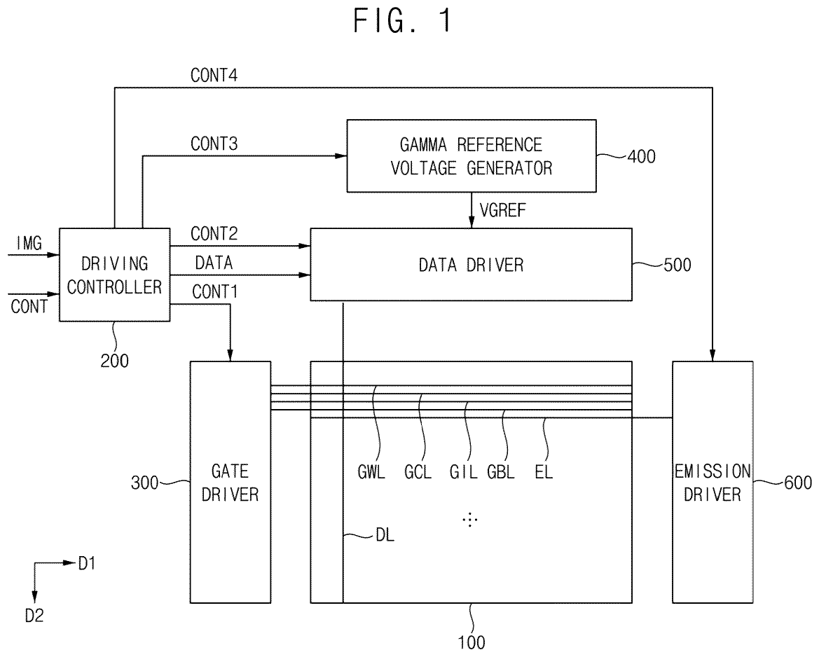

FIG. 1 is a block diagram illustrating a display apparatus according to an embodiment of the disclosure.

Referring to FIG. 1, the display apparatus may include a display panel 100 and a display panel driver. The display panel driver may include a driving controller 200, a gate driver 300, a gamma reference voltage generator 400, a data driver 500 and an emission driver 600.

The display panel 100 may have a display region on which an image is displayed and a peripheral region adjacent to the display region.

The display panel 100 may include a plurality of gate lines GWL, GCL, GIL, and GBL, a plurality of data lines DL, a plurality of emission lines EL and a plurality of pixels electrically connected to the gate lines GWL, GCL, GIL, and GBL, the data lines DL and the emission lines EL. The gate lines GWL, GCL, GIL, and GBL may extend in a first direction D1, the data lines DL may extend in a second direction D2 intersecting the first direction D1 and the emission lines EL may extend in the first direction D1.

The driving controller 200 may receive input image data IMG and an input control signal CONT from an external apparatus (e.g., a processor, an application processor, a host, and a set). For example, the input image data IMG may include red image data, green image data, and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 to control an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 to control an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 to control an operation of the gamma reference voltage generator 400 based on the input control signal CONT, and may output the third control signal CONT3 to the gamma reference voltage generator 400.

The driving controller 200 may generate the fourth control signal CONT4 to control an operation of the emission driver 600 based on the input control signal CONT, and may output the fourth control signal CONT4 to the emission driver 600.

The gate driver 300 may generate gate signals driving the gate lines GWL, GCL, GIL, and GBL in response to the first control signal CONT1 received from the driving controller 200. The gate driver 300 may output the gate signals to the gate lines GWL, GCL, GIL, and GBL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA into analog-type data voltages using the gamma reference voltages VGREF. The data driver 500 may output the data voltages to the data lines DL.

The emission driver 600 may generate emission signals to drive the emission lines EL in response to the fourth control signal CONT4 received from the driving controller 200. The emission driver 600 may output the emission signals to the emission lines EL.

Although the gate driver 300 is disposed at a first side of the display panel 100 and the emission driver 600 is disposed at a second side of the display panel 100 opposite to the first side shown in FIG. 1 for convenience of explanation, the disclosure may not be limited thereto. For example, both the gate driver 300 and the emission driver 600 may be disposed at the first side of the display panel 100. For example, both the gate driver 300 and the emission driver 600 may be disposed at sides (e.g., opposite sides) of the display panel 100. For example, the gate driver 300 and the emission driver 600 may be integral with each other.

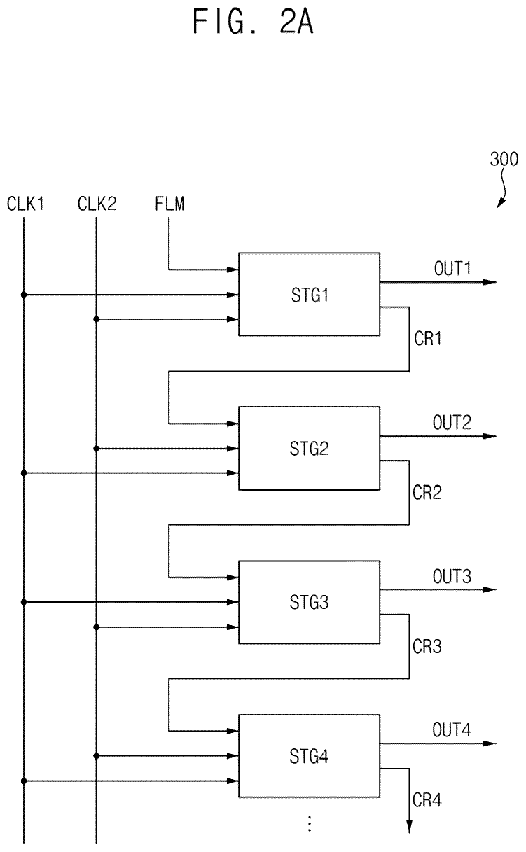

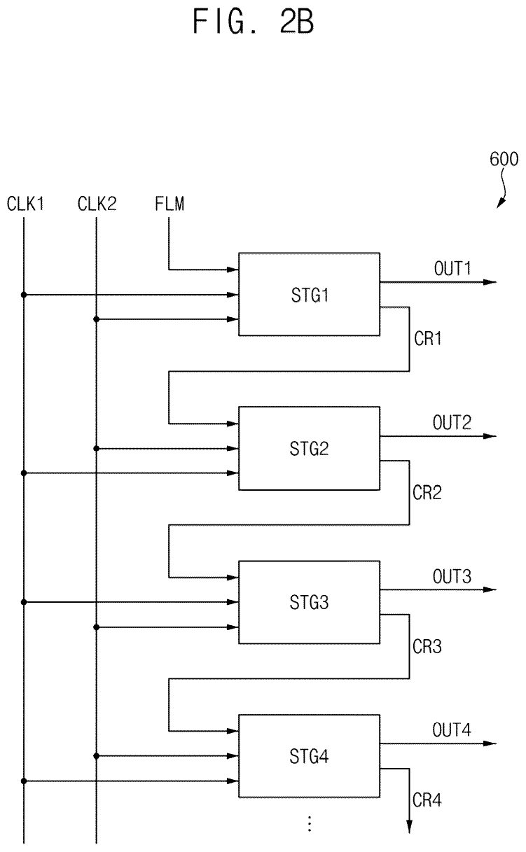

FIG. 2A is a block diagram illustrating a gate driver 300 of FIG. 1. FIG. 2B is a block diagram illustrating an emission driver 600 of FIG. 1. FIG. 3 is a timing diagram illustrating an example of an operation of the driver of FIG. 2A or FIG. 2B.

For example, the driver may be the gate driver 300 outputting the gate signal in FIG. 2A. For example, the driver may be the emission driver 600 outputting the emission signal in FIG. 2B. For example, the driver according to the disclosure may be applied to the gate driver 300 and the emission driver 600.

Referring to FIGS. 2A and 2B, the driver according to embodiments of the disclosure may include a plurality of stages STG1, STG2, STG3, STG4, .... The driver may be implemented as a shift register in which the stages STG1, STG2, STG3, STG4, ... sequentially output carry signals CR1, CR2, CR3, CR4, . . . and output signals OUT1, OUT2, OUT3, OUT4, . . . . For example, the driver may be included in the display apparatus and be formed on the display panel 100. For example, the driver may be integrated or disposed on a substrate of the display panel 100. Each of the stages STG1, STG2, STG3, STG4, . . . may be a circuit block comprising a plurality of circuit elements.

The stages STG1, STG2, STG3, STG4, . . . may sequentially output the output signals OUT1, OUT2, OUT3, OUT4, . . . based on a start signal FLM, a first clock signal CLK1 and a second clock signal CLK2 having a phase different from a phase of the first clock signal CLK1. A first stage STG1 may receive the start signal FLM as an input signal and each of subsequent stages STG2, STG3, STG4, . . . may receive the carry signal CR1, CR2, CR3, . . . of previous stages as the input signals. For example, a second stage STG2 may receive a first carry signal CR1 of the first stage STG1 as the input signal, a third stage STG3 may receive a second carry signal CR2 of the second stage STG2 as the input signal, and a fourth stage STG4 may receive a third carry signal CR3 of the third stage STG3 as the input signal. Thus, the stages STG1, STG2, STG3, STG4, . . . may be connected in series while receiving the same first clock signal CLK1 and second clock signal CLK2. The stages may be classified into odd-numbered stages STGO (e.g., STG1, STG3, . . . ) positioned in odd-numbered rows and even-numbered stages STGE (e.g., STG2, STG4, . . . ) positioned in even-numbered rows. The odd-numbered stages STGO may have a configuration different from that of the even-numbered stages STGE, as will be described in detail below.

For example, a phase of the second clock signal CLK2 may be opposite to a phase of the first clock signal CLK1. The first clock signal CLK1 may have a high level and the second clock signal CLK2 may have a low level in a first period P1, a third period P3, a fifth period P5, a seventh period P7, a ninth period P9, an eleventh period P11, a thirteenth period P13, a fifteenth period P15 and a seventeenth period P17. The second clock signal CLK2 may have a high level and the first clock signal CLK1 may have a low level in a second period P2, a fourth period P4, a sixth period P6, an eighth period P8, a tenth period P10, a twelfth period P12, a fourteenth period P14, a sixteenth period P16, and an eighteenth period P18.

In an embodiment, when the first clock signal CLK1 has a low level and the second clock signal CLK2 has a high level, the odd-numbered stages STGO including STG1, STG3, . . . may start to output signals OUT1, OUT3, .... When the second clock signal CLK2 has a low level and the first clock signal CLK1 has a high level, the even-numbered stages STGE including STG2, STG4, . . . may start to output signals OUT2, OUT4, . . . .

For example, as shown in FIGS. 2A, 2B, and 3, when the first clock signal CLK1 becomes (or transitions to) a low level after the start signal FLM becomes (or transitions to) a high level, the first stage STG1 may start to output a first output signal OUT1 having a high level. When the first clock signal CLK1 becomes (or transitions to) the low level after the start signal FLM becomes (or transitions to) a low level, the first stage STG1 may start to output the first output signal OUT1 having a low level.

The second clock signal CLK2 becomes (or transitions to) a low level after the first output signal OUT1 becomes (or transitions to) the high level (after the first carry signal CR1 becomes (or transitions to) a low level), the second stage STG2 may start to output a second output signal OUT2 having a high level. When the second clock signal CLK2 becomes (or transitions to) the low level after the first output signal OUT1 becomes (or transitions to) a low level (after the first carry signal CR1 becomes (or transitions to) a high level), the second stage STG2 may start to output the second output signal OUT2 having a low level.

The first clock signal CLK1 becomes (or transitions to) the low level after the second output signal OUT2 becomes (or transitions to) the high level (after the second carry signal CR2 becomes (or transitions to) a high level), the third stage STG3 may start to output a third output signal OUT3 having a high level. When the first clock signal CLK1 becomes (or transitions to) the low level after the second output signal OUT2 becomes (or transitions to) a low level (after the second carry signal CR2 becomes (or transitions to) a low level), the third stage STG3 may start to output the third output signal OUT3 having a low level.

Thus, the stages STG1, STG2, STG3, STG4, . . . may sequentially output the output signals OUT1, OUT2, OUT3, OUT4, . . . by delaying and shifting the output signals OUT1, OUT2, OUT3, OUT4, . . . by half a cycle of the first clock signal CLK1.

In the embodiment, both the first clock signal CLK1 and the second clock signal CLK2 may be applied to each stage.

In the embodiment, a phase of a present carry signal CR1, CR3, . . . may be opposite to a phase of the output signal OUT1, OUT3, . . . in one of the odd-numbered stages STGO (e.g., STG1, STG3, . . . ). In contrast, a phase of a present carry signal CR2, CR4, . . . may be the same as a phase of the output signal OUT2, OUT4, . . . in one of the even-numbered stages STGE (e.g., STG2, STG4, . . . ).

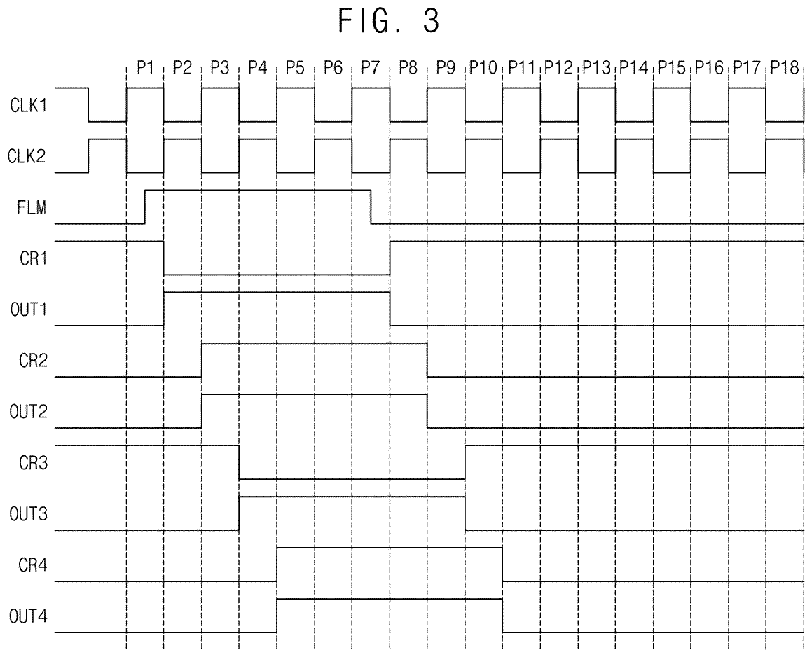

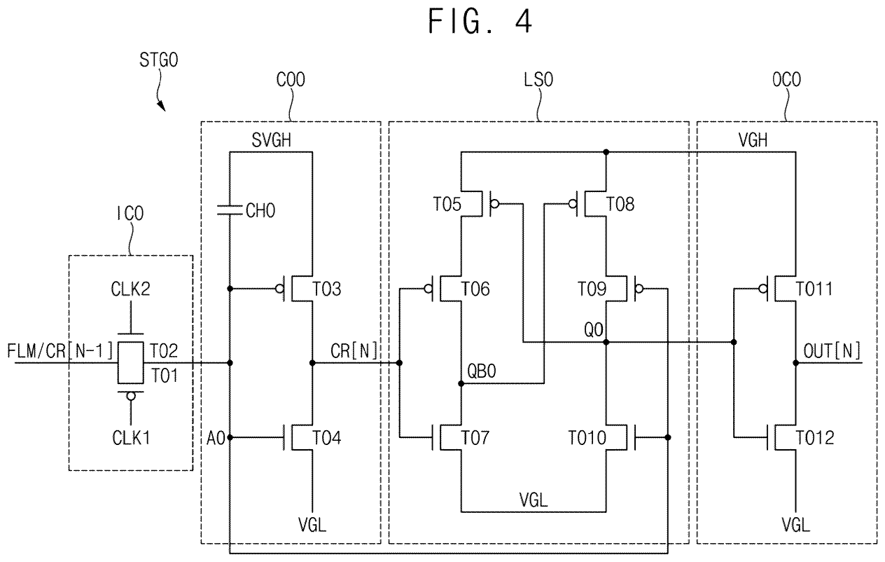

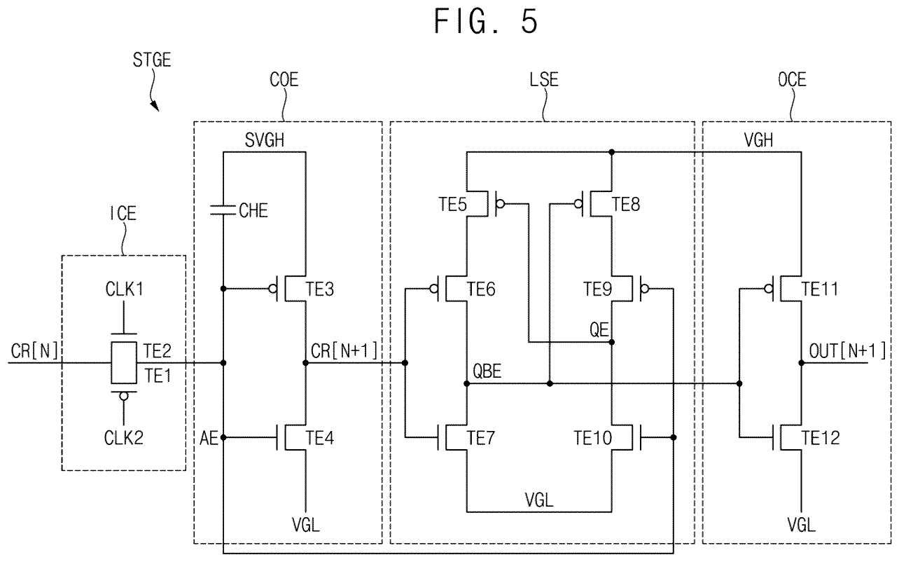

FIG. 4 is a circuit diagram illustrating an odd-numbered stage of the driver of FIG. 2A and FIG. 2B. FIG. 5 is a circuit diagram illustrating an even-numbered stage of the driver of FIG. 2A and FIG. 2B. FIG. 6 is a timing diagram illustrating an example of an operation of the stage of FIG. 4 and FIG. 5.

Referring to FIG. 4, the odd-numbered stage STGO may include an input circuit ICO transmitting a previous carry signal (e.g., CR[N−1]) or the start signal FLM to a first control node AO in response to the first clock signal CLK1 and the second clock signal CLK2 having a phase different from a phase of the first clock signal CLK1, a carry output circuit COO generating a present carry signal (e.g., CR[N]) based on a first high power voltage SVGH and a low power voltage VGL in response to a signal of the first control node AO, a level shifter LSO generating a signal of a second control node QO and a signal of a third control node QBO in response to a second high power voltage VGH, which is greater than the first high power voltage SVGH, and the low power voltage VGL, and an output circuit OCO generating an output signal (e.g., OUT[N]) based on the second high power voltage VGH and the low power voltage VGL in response to the signal of the second control node QO.

Referring to FIG. 5, the even-numbered stage STGE may include an input circuit ICE transmitting a previous carry signal (e.g., CR[N]) to a first control node AE in response to the first clock signal CLK1 and the second clock signal CLK2, a carry output circuit COE generating a present carry signal (e.g., CR[N+1]) based on the first high power voltage SVGH and the low power voltage VGL in response to a signal of the first control node AE, a level shifter LSE generating a signal of a second control node QE and a signal of a third control node QBE in response to the second high power voltage VGH and the low power voltage VGL and an output circuit OCE generating an output signal (e.g., OUT[N+1]) based on the second high power voltage VGH and the low power voltage VGL in response to the signal of the third control node QBE.

When the odd-numbered stage STGO is a first stage, the input circuit ICO may receive the start signal FLM. When the odd-numbered stage STGO is not the first stage (e.g., is an N-th stage), the input circuit ICO may receive a previous carry signal (e.g., CR[N−1]).

In the embodiment, the previous carry signal may not be limited to a carry signal of an immediately (or directly) previous stage preceding a present stage. The previous carry signal may be a carry signal of one of previous stages preceding the present stage.

The input circuit ICE of the even-numbered stage STGE (e.g., is an (N+1)-th stage) may receive a previous carry signal (e.g., CR[N]).

Hereinafter, structures of the input circuit ICO and/or ICE, the carry output circuit COO and/or COE, the level shifter LSO and/or LSE, and the output circuit OCO and/or COE are explained in detail.

The input circuit ICO of the odd-numbered stage STGO may include a first transistor TO1 including a control electrode receiving the first clock signal CLK1, a first electrode receiving the previous carry signal CR[N−1] and a second electrode connected to the first control node AO and a second transistor TO2 including a control electrode receiving the second clock signal CLK2, a first electrode receiving the previous carry signal CR[N−1] and a second electrode connected to the first control node AO.

The carry output circuit COO of the odd-numbered stage STGO may include a third transistor TO3 including a control electrode connected to the first control node AO, a first electrode receiving the first high power voltage SVGH and a second electrode connected to a carry output node and a fourth transistor TO4 including a control electrode connected to the first control node AO, a first electrode receiving the low power voltage VGL and a second electrode connected to the carry output node.

The carry output circuit COO of the odd-numbered stage STGO may further include a capacitor CHO including a first electrode receiving the first high power voltage SVGH and a second electrode connected to the first control node AO.

When the first clock signal CLK1 and the second clock signal CLK2 continuously oscillating or swing without stopping, the previous carry signal (e.g., CR[N−1]) or the start signal FLM may be periodically applied to the first control node AO. When the display apparatus operates in a power reduction mode, such as by being driven at a low frequency to reduce a power consumption, a swing (or oscillation) of the first clock signal CLK1 and a swing of the second clock signal CLK2 may be temporarily stopped or hold.

When the swing (or oscillation) of the first clock signal CLK1 and the swing (or oscillation) of the second clock signal CLK2 are temporarily stopped, a signal of the first control node AO may become a floating state so that a high level of the signal of the first control node AO may be changed to a low level or the low level of the signal of the first control node AO may be changed to the high level. When the high level of the signal of the first control node AO is changed to the low level or the low level of the signal of the first control node AO is changed to the high level, a level of the output signal OUT[N] may be changed so that a reliability of the driver may be reduced.

Although the swing of the first clock signal CLK1 and the swing of the second clock signal CLK2 are temporarily stopped, the stage may include the capacitor CHO connected to the first control node AO so that the signal of the first control node AO may be stably maintained and the reliability of the driver may be enhanced.

The level shifter LSO of the odd-numbered stage STGO may include a fifth transistor TO5 including a control electrode connected to the second control node QO, a first electrode receiving the second high power voltage VGH and a second electrode connected to a first intermediate node, a sixth transistor TO6 including a control electrode connected to the carry output node, a first electrode connected to the first intermediate node and a second electrode connected to the third control node QBO, a seventh transistor TO7 including a control electrode connected to the carry output node, a first electrode receiving the low power voltage VGL and a second electrode connected to the third control node QBO, an eighth transistor TO8 including a control electrode connected to the third control node QBO, a first electrode receiving the second high power voltage VGH and a second electrode connected to a second intermediate node, a ninth transistor TO9 including a control electrode connected to the first control node AO, a first electrode connected to the second intermediate node and a second electrode connected to the second control node QO and a tenth transistor TO10 including a control electrode connected to the first control node AO, a first electrode receiving the low power voltage VGL and a second electrode connected to the second control node QO.

The output circuit OCO of the odd-numbered stage STGO may include an eleventh transistor TO11 including a control electrode connected to the second control node QO, a first electrode receiving the second high power voltage VGH and a second electrode connected to an output node and a twelfth transistor TO12 including a control electrode connected to the second control node QO, a first electrode receiving the low power voltage VGL and a second electrode connected to the output node.

The first transistor TO1, the third transistor TO3, the fifth transistor TO5, the sixth transistor TO6, the eighth transistor TO8, the ninth transistor TO9 and the eleventh transistor TO11 of the odd-numbered stage STGO may be P-type transistors. The second transistor TO2, the fourth transistor TO4, the seventh transistor TO7, the tenth transistor TO10 and the twelfth transistor TO12 may be N-type transistors.

In the embodiment, the odd-numbered stage STGO and the even-numbered stage STGE of the driver may have different structures.

For example, in the odd-numbered stage STGO, the first clock signal CLK1 may be applied to the control electrode of the first transistor TO1 of the odd-numbered stage STGO and the second clock signal CLK2 may be applied to the control electrode of the second transistor TO2 of the odd-numbered stage STGO. In the even-numbered stage STGE, the second clock signal CLK2 may be applied to the control electrode of the first transistor TE1 of the even-numbered stage STGE and the first clock signal CLK1 may be applied to the control electrode of the second transistor TE2 of the even-numbered stage STGE.

For example, the control electrode of the eleventh transistor TO11 of the odd-numbered stage STGO and the control electrode of the twelfth transistor TO12 of the odd-numbered stage STGO may be connected to the second control node QO of the odd-numbered stage STGO. In contrast, the control electrode of the eleventh transistor TE11 of the even-numbered stage STGE and the control electrode of the twelfth transistor TE12 of the even-numbered stage STGE may be connected to the third control node QBE of the even-numbered stage STGE.

For example, the output circuit OCE of the even-numbered stage STGE may include the eleventh transistor TE11 including a control electrode connected to the third control node QBE, a first electrode receiving the second high power voltage VGH and a second electrode connected to an output node and the twelfth transistor TE12 including a control electrode connected to the third control node QBE, a first electrode receiving the low power voltage VGL and a second electrode connected to the output node.

The carry output circuit COE of the even-numbered stage STGE and the level shifter LSE may have a structure substantially the same as the carry output circuit COO of the odd-numbered stage STGO and the level shifter LSO.

The first transistor TE1, a third transistor TE3, a fifth transistor TE5, a sixth transistor TE6, an eighth transistor TE8, a ninth transistor TE9 and the eleventh transistor TE11 of the even-numbered stage STGE may be P-type transistors. The second transistor TE2, a fourth transistor TE4, a seventh transistor TE7, a tenth transistor TE10 and the twelfth transistor TE12 may be N-type transistors.

Referring to FIGS. 1 to 6, when the stage is the odd-numbered stage STGO, a phase of the present carry signal CR[N] may be opposite to a phase of the output signal OUT[N] of the output circuit OCO. When the stage is the even-numbered stage STGE, a phase of the present carry signal CR[N+1] may be opposite to a phase of the output signal OUT[N+1] of the output circuit OCE.

For example, when the stage is the odd-numbered stage STGO, a phase of the signal of the first control node AO may be substantially the same as the phase of the output signal OUT[N] of the output circuit OCO. When the stage is the even-numbered stage STGE, a phase of the signal of the first control node AE may be opposite to the phase of the output signal OUT[N+1] of the output circuit OCE.

For example, a high level of the start signal FLM, a high level of the carry signals (e.g., CR[N] and CR[N+1]), a high level of the first clock signal CLK1 and a high level of the second clock signal CLK2 may be the first high power voltage SVGH. A low level of the start signal FLM, a low level of the carry signal (e.g., CR[N] and CR[N+1]), a low level of the first clock signal CLK1 and a low level of the second clock signal CLK2 may be the low power voltage VGL. A high level of the output signals OUT[N] and OUT[N+1] may be the second high power voltage VGH. A low level of the output signals OUT[N] and OUT[N+1] may be the low power voltage VGL.

For example, a high level of the signal of the first control node AO and AE may be the first high power voltage SVGH. A low level of the signal of the first control node AO and AE may be the low power voltage VGL.

In an embodiment of the embodiment, a high level of the signal of the second control node QO and QE and a high level of the signal of the third control node QBO and QBE may be the second high power voltage VGH. A low level of the signal of the second control node QO and QE and a low level of the signal of the third control node QBO and QBE may be the low power voltage VGL.

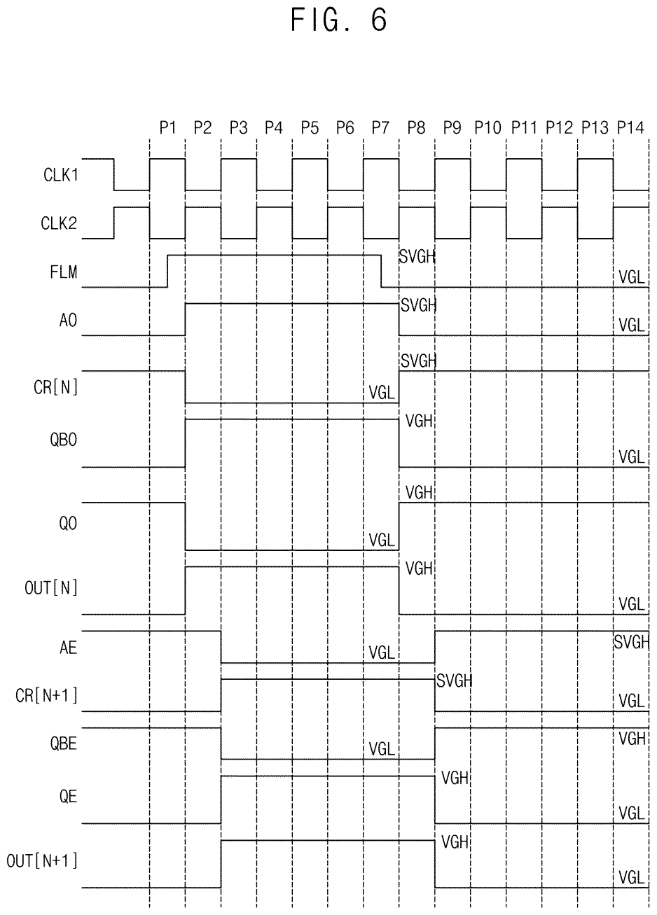

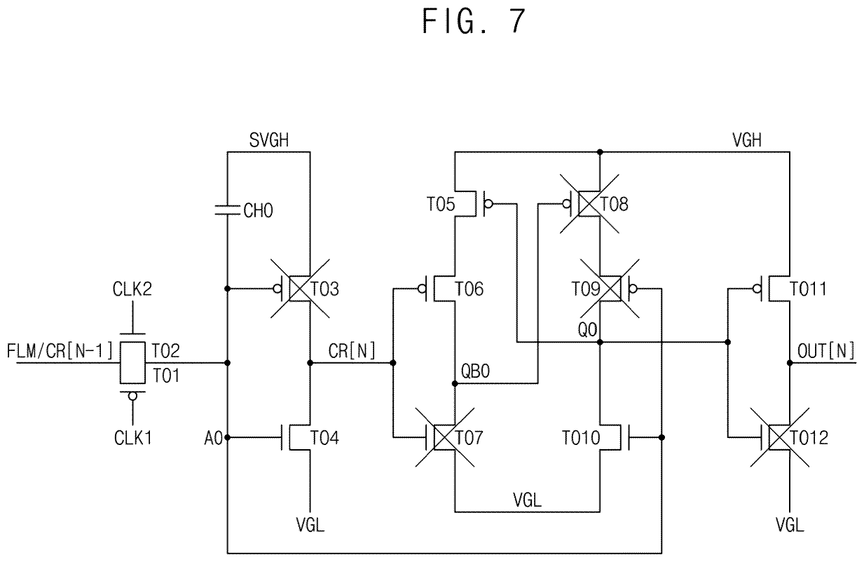

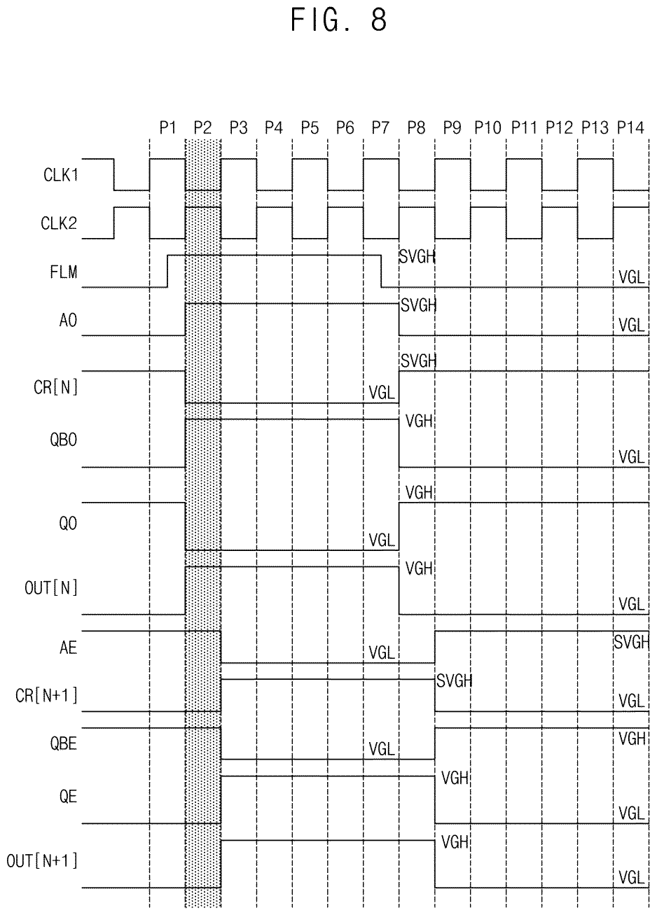

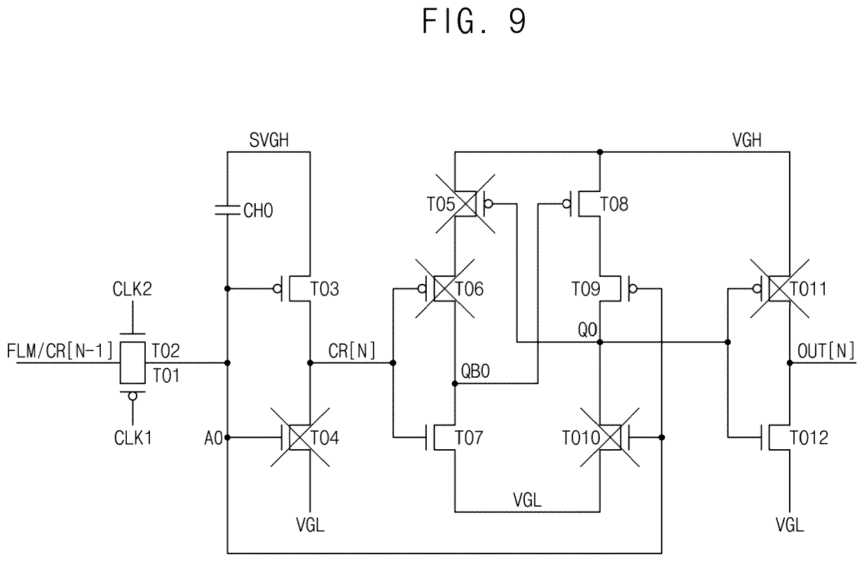

FIG. 7 is a circuit diagram illustrating an example of an operation of the stage of FIG. 4 in a second period P2 of FIG. 6. FIG. 8 is a circuit diagram illustrating an example of an operation of the stage of FIG. 4 in the second period P2 of FIG. 6. FIG. 9 is a circuit diagram illustrating an example of an operation of the stage of FIG. 4 in an eighth period P8 of FIG. 6. FIG. 10 is a circuit diagram illustrating an example of an operation of the stage of FIG. 4 in the eighth period P8 of FIG. 6.

Referring to FIGS. 1 to 10, in the second period P2, the first transistor TO1 and the second transistor TO2 may be turned on in response to the first clock signal CLK1 and the second clock signal CLK2 so that the input signal FLM or CR[N−1] may be applied to the first control node AO.

In the second period P2, the fourth transistor TO4 may be turned on in response to a high level (corresponding to the first high power voltage SVGH) of the first control node AO so that the present carry signal CR[N] having the low power voltage VGL may be generated.

In the second period P2, the tenth transistor TO10 may be turned on in response to a high level (corresponding to the first high power voltage SVGH) of the first control node AO so that the signal of the second control node QO may have the low power voltage VGL.

In the second period P2, the fifth transistor TO5 and the sixth transistor TO6 may be turned on in response to the present carry signal CR[N] having the low power voltage VGL and the signal of the second control node QO having the low power voltage VGL so that the signal of the third control node QBO may have the second high power voltage VGH.

In the second period P2, the eleventh transistor TO11 may be turned on in response to the signal of the second control node QO having the low power voltage VGL so that the output signal OUT[N] having the second high power voltage VGH may be outputted.

In the eighth period P8, the first transistor TO1 and the second transistor TO2 may be turned on in response to the first clock signal CLK1 and the second clock signal CLK2 so that the input signal FLM or CR[N−1] may be applied to the first control node AO.

In the eighth period P8, the third transistor TO3 may be turned on in response to a low level VGL of the first control node AO so that the present carry signal CR[N] having the first high power voltage SVGH may be generated.

In the eighth period P8, the seventh transistor TO7 may be turned on in response to the present carry signal CR[N] having the first high power voltage SVGH so that the signal of the third control node QBO may have the low power voltage VGL.

In the eighth period P8, the eighth transistor TO8 and the ninth transistor TO9 may be turned on in response to the signal of the third control node QBO having the low power voltage VGL and the signal of the first control node AO having the low power voltage VGL so that the signal of the second control node QO may have the second high power voltage VGH.

In the eighth period P8, the twelfth transistor TO12 may be turned on in response to the signal of the second control node QO having the second high power voltage VGH so that the output signal OUT[N] having the low power voltage VGL may be outputted.

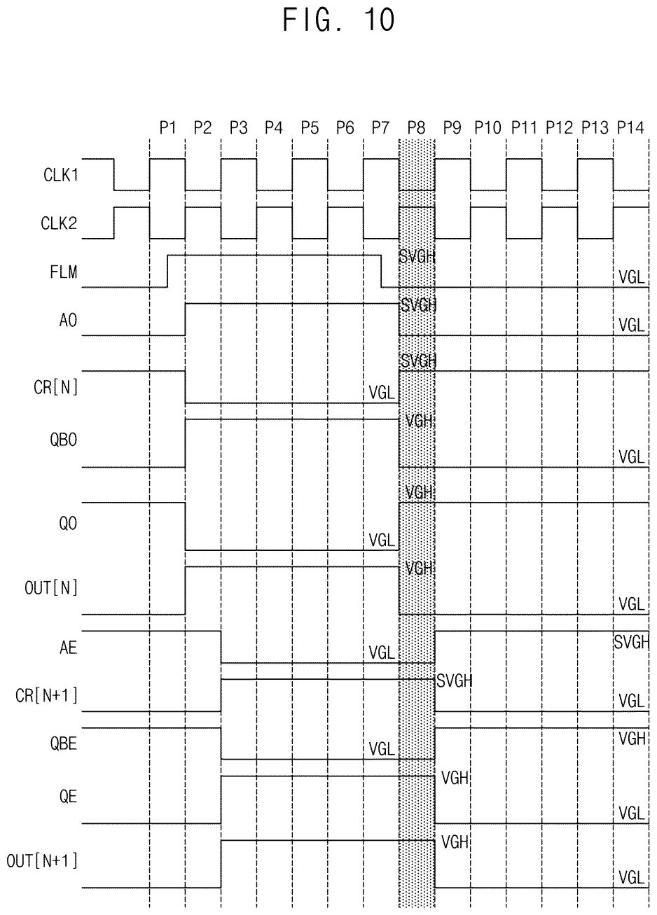

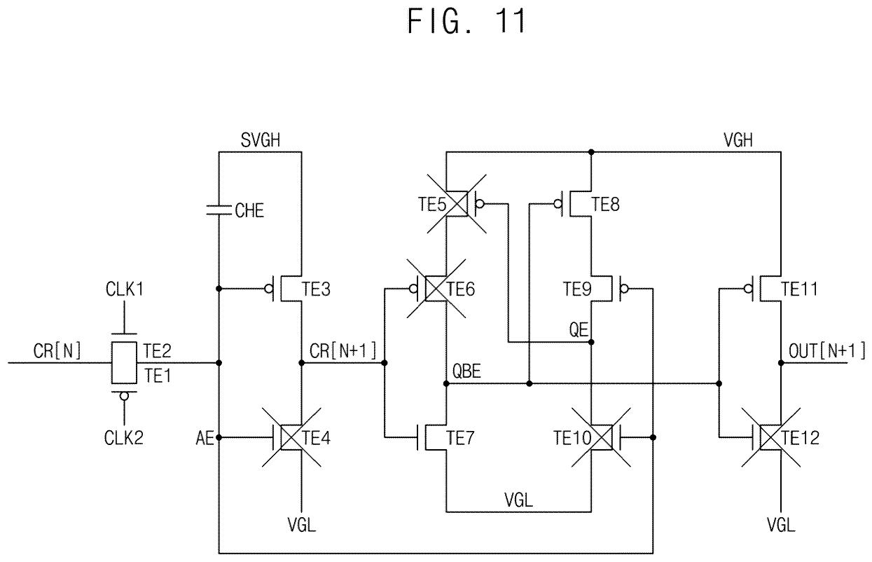

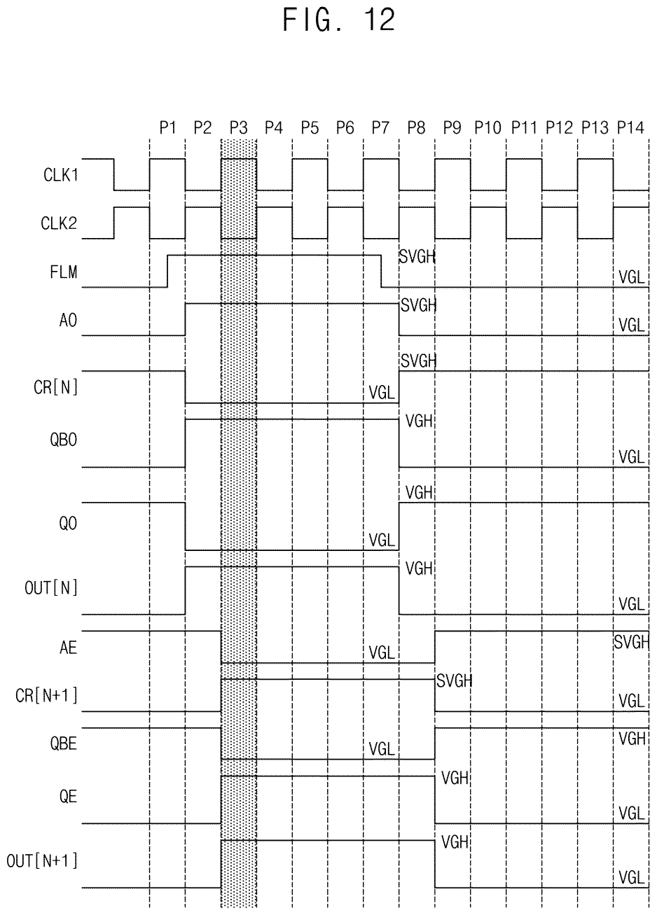

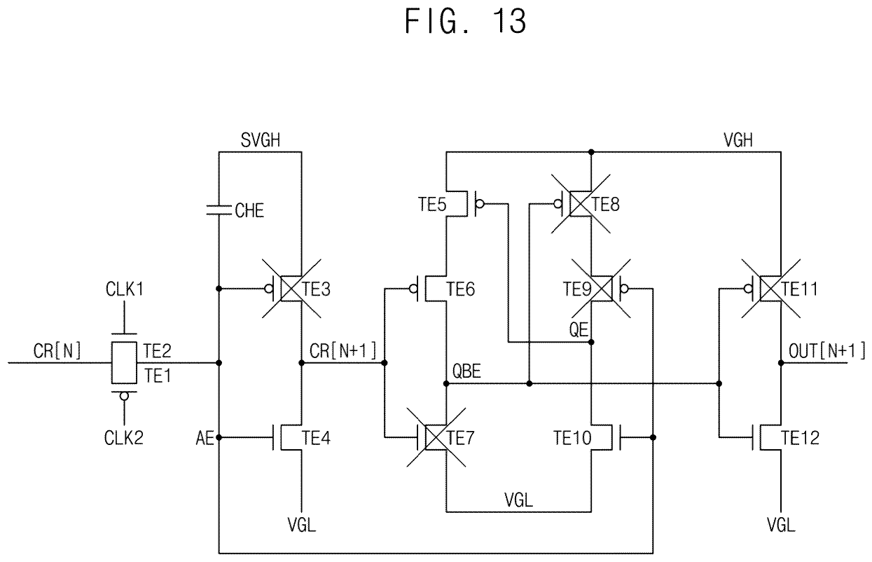

FIG. 11 is a circuit diagram illustrating an example of an operation of the stage of FIG. 5 in a third period P3 of FIG. 6. FIG. 12 is a circuit diagram illustrating an example of an operation of the stage of FIG. 5 in the third period P3 of FIG. 6. FIG. 13 is a circuit diagram illustrating an example of an operation of the stage of FIG. 5 in a ninth period P9 of FIG. 6. FIG. 14 is a circuit diagram illustrating an example of an operation of the stage of FIG. 5 in the ninth period P9 of FIG. 6.

Referring to FIGS. 1 to 14, in the third period P3, the first transistor TE1 and the second transistor TE2 may be turned on in response to the first clock signal CLK1 and the second clock signal CLK2 so that the input signal CR[N] may be applied to the first control node AE.

In the third period P3, the third transistor TE3 may be turned on in response to a low level VGL of the first control node AE so that the present carry signal CR[N+1] having the first high power voltage SVGH may be generated.

In the third period P3, the seventh transistor TE7 may be turned on in response to the present carry signal CR[N+1] having the first high power voltage SVGH so that the signal of the third control node QBE may have the low power voltage VGL.

In the third period P3, the eighth transistor TE8 and the ninth transistor TE9 may be turned on in response to the signal of the third control node QBE having the low power voltage VGL and the signal of the first control node AE having the low power voltage VGL so that the signal of the second control node QE may have the second high power voltage VGH.

In the third period P3, the eleventh transistor TE11 may be turned on in response to the signal of the third control node QBE having the low power voltage VGL so that the output signal OUT[N+1] having the second high power voltage VGH may be outputted.

In the ninth period P9, the first transistor TE1 and the second transistor TE2 may be turned on in response to the first clock signal CLK1 and the second clock signal CLK2 so that the input signal CR[N] may be applied to the first control node AE.

In the ninth period P9, the fourth transistor TE4 may be turned on in response to a high level (corresponding to the first high power voltage SVGH) of the first control node AE so that the present carry signal CR[N+1] having the low power voltage VGL may be generated.

In the ninth period P9, the tenth transistor TE10 may be turned on in response to a high level (corresponding to the first high power voltage SVGH) of the first control node AE so that the signal of the second control node QE may have the low power voltage VGL.

In the ninth period P9, the fifth transistor TE5 and the sixth transistor TE6 may be turned on in response to the present carry signal CR[N+1] having the low power voltage VGL and the signal of the second control node QE having the low power voltage VGL so that the signal of the third control node QBE may have the second high power voltage VGH.

In the ninth period P9, the twelfth transistor TE12 may be turned on in response to the signal of the third control node QBE having the second high power voltage VGH so that the output signal OUT[N+1] having the low power voltage VGL may be outputted.

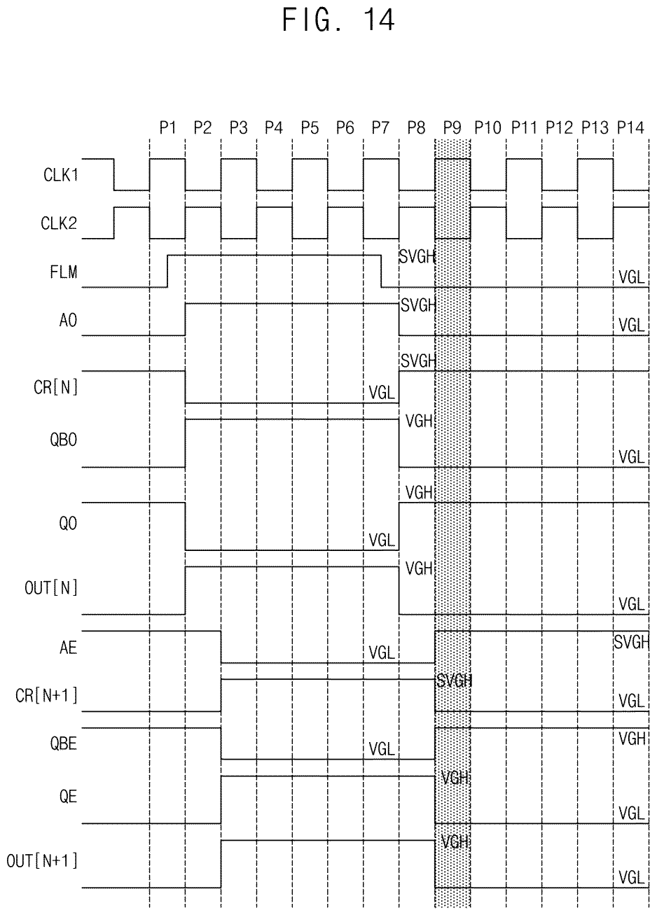

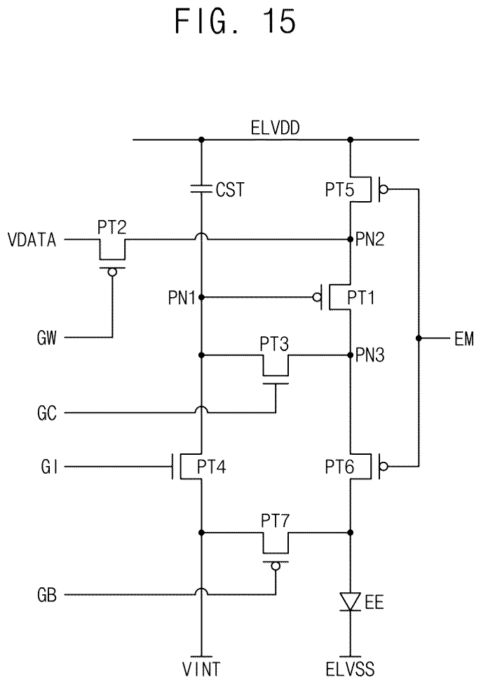

FIG. 15 is a circuit diagram illustrating an example of the pixel of the display panel 100 of FIG. 1. FIG. 16 is a timing diagram illustrating an example of input signals of the pixel of FIG. 15.

Referring to FIGS. 1 to 16, the display panel 100 may include the plurality of pixels. Each pixel may include a light emitting element EE.

The pixel may receive a writing gate signal GW, a compensation gate signal GC, a data initialization gate signal GI, a light emitting element initialization gate signal GB, the data voltage VDATA and the emission signal EM and the light emitting element EE of the pixel emits light corresponding to the level of the data voltage VDATA to display the image.

In the embodiment, the pixel may include a switching element of a first type and a switching element of a second type different from the first type. For example, the switching element of the first type may be a P-type transistor and the switching element of the second type may be an N-type transistor.

For example, the switching element of the first type may be a polycrystalline silicon thin film transistor. For example, the switching element of the first type may be a low temperature polycrystalline silicon (LTPS) thin film transistor. For example, the switching element of the second type may be an oxide semiconductor thin film transistor.

In another example, the pixel may include the P-type transistors only or N-type transistors only.

At least one of the pixels may include first to seventh pixel switching elements PT1 to PT7, a storage capacitor CST and the light emitting element EE.

The first pixel switching element PT1 may include a control electrode connected to a first pixel node PN1, a first electrode connected to a second pixel node PN2 and a second electrode connected to a third pixel node PN3.

The second pixel switching element PT2 may include a control electrode receiving the writing gate signal GW, a first electrode receiving the data voltage VDATA and a second electrode connected to the second pixel node PN2.

The third pixel switching element PT3 may include a control electrode receiving the compensation gate signal GC, a first electrode connected to the first pixel node PN1 and a second electrode connected to the third pixel node PN3.

The fourth pixel switching element PT4 may include a control electrode receiving the data initialization gate signal GI, a first electrode receiving an initialization voltage VINT and a second electrode connected to the first pixel node PN1.

The fifth pixel switching element PT5 may include a control electrode receiving the emission signal EM, a first electrode receiving a pixel high power voltage ELVDD and a second electrode connected to the second pixel node PN2.

The sixth pixel switching element PT6 may include a control electrode receiving the emission signal EM, a first electrode connected to the third pixel node PN3 and a second electrode connected to an anode electrode of the light emitting element EE.

The seventh pixel switching element PT7 may include a control electrode receiving the light emitting element initialization gate signal GB, a first electrode receiving the initialization voltage VINT and a second electrode connected to the anode electrode of the light emitting element EE.

The storage capacitor CST may include a first electrode receiving the pixel high power voltage ELVDD and a second electrode connected to the first pixel node PN1.

The light emitting element EE may include the anode electrode and a cathode electrode receiving a pixel low power voltage ELVSS.

In the embodiment, the third pixel switching element PT3 and the fourth pixel switching element PT4 may be N-type transistors. The first pixel switching element PT1, the second pixel switching element PT2, the fifth pixel switching element PT5, the sixth pixel switching element PT6 and the seventh pixel switching element PT7 may be P-type transistors.

Referring to FIG. 16, in a first pixel driving period DU1, the first pixel node PN1 and the storage capacitor CST may be initialized in response to the data initialization gate signal GI. In a second pixel driving period DU2, a threshold voltage |VTH|of the first pixel switching element PT1 may be compensated and the data voltage VDATA, of which the threshold voltage |VTH|is compensated, may be written to the first pixel node PN1 in response to the writing gate signals GW and the compensation gate signal GC. In a third pixel driving period DU3, the anode electrode of the light emitting element EE may be initialized in response to the light emitting element initialization gate signal GB. In a fourth pixel driving period DU4, the light emitting element EE may emit the light in response to the emission signal EM so that the display panel 100 may display the image.

Although an emission off period of the emission signal EM corresponds to first to third periods DU1, DU2 and DU3 in the embodiment, the disclosure is not limited thereto. The emission off period of the emission signal EM may be set to include the data writing pixel driving period DU2. The emission off period of the emission signal EM may be longer than a sum of the first to third periods DU1, DU2 and DU3.

In the first pixel driving period DU1, the data initialization gate signal GI may have an active level. For example, the active level of the data initialization gate signal GI may be a high level. When the data initialization gate signal GI has the active level, the fourth pixel switching element PT4 may be turned on so that the initialization voltage VINT may be applied to the first pixel node PN1.

In the second pixel driving period DU2, the writing gate signal GW and the compensation gate signal GC may have an active level. For example, the active level of the writing gate signal GW may be a low level and the active level of the compensation gate signal GC may be a high level. When the writing gate signal GW and the compensation gate signal GC have the active level, the second pixel switching element PT2 and the third pixel switching element PT3 may be turned on. For example, the first pixel switching element PT1 may be turned on in response to the initialization voltage VINT.

A voltage equal to the data voltage VDATA minus an absolute value |VTH| of the threshold voltage of the first pixel switching element PT1 may be charged at the first pixel node PN1 along a path generated by the first to third pixel switching elements PT1, PT2 and PT3.

In the third pixel driving period DU3, the light emitting element initialization gate signal GB may have an active level. For example, the active level of the light emitting element initialization gate signal GB may be a low level. When the light emitting element initialization gate signal GB has the active level, the seventh pixel switching element PT7 may be turned on so that the initialization voltage VINT may be applied to the anode electrode of the light emitting element EE.

Although, the initialization voltage applied to the fourth pixel switching element PT4 may be the same as the initialization voltage applied to the seventh pixel switching element PT7 in the embodiment, the disclosure is not limited thereto. In an embodiment, the initialization voltage applied to the fourth pixel switching element PT4 may be different from the initialization voltage applied to the seventh pixel switching element PT7.

In the fourth pixel driving period DU4, the emission signal EM may have an active level. For example, the active level of the emission signal EM may be a low level. When the emission signal EM has the active level, the fifth pixel switching element PT5 and the sixth pixel switching element PT6 may be turned on. For example, the first pixel switching element PT1 may be turned on by the data voltage VDATA.

A driving current may flow through the fifth pixel switching element PT5, the first pixel switching element PT1 and the sixth pixel switching element PT6 to drive the light emitting element EE. An intensity of the driving current may be determined by the level of the data voltage VDATA. A luminance of the light emitting element EE may be determined by the intensity of the driving current.

Referring to FIG. 16, [N] indicates a signal of a present stage. A signal of a previous stage or a signal of a next stage may not be applied to the pixel circuit of FIGS. 15 and 16 so that “[N]” notation may be omitted from FIG. 16.

For example, the output signals OUT[N] and OUT[N+1] of the stages STGO and STGE of FIGS. 4 and 5 may be the compensation gate signal GC applied to the third pixel switching element PT3.

For example, the output signals OUT[N] and OUT[N+1] of the stages STGO and STGE STGO and STGE of FIGS. 4 and 5 may be the data initialization gate signal GI applied to the fourth pixel switching element PT4.

For example, the output signals OUT[N] and OUT[N+1] of the stages STGO and STGE of FIGS. 4 and 5 may be the light emitting element initialization gate signal GB applied to the seventh pixel switching element PT7.

For example, the output signals OUT[N] and OUT[N+1] of the stages STGO and STGE of FIGS. 4 and 5 may be the emission signal EM applied to the fifth pixel switching element PT5 and the sixth pixel switching element PT6.

According to the embodiment, the driver may include the level shifter LSO and/or LSE so that the first and second clock signals CLK1 and CLK2 and the carry signals CR[N−1], CR[N] and CR[N+1] may swing (or oscillate) between the first high power voltage SVGH and the low power voltage VGL and the output signals OUT[N] and OUT[N+1] may swing (or oscillate) between the second high power voltage VGH, which is higher than the first high power voltage SVGH, and the low power voltage VGL.

The swing range of the first and second clock signals CLK1 and CLK2 and the carry signals CR[N−1], CR[N] and CR[N+1] of the driver may be reduced so that the power consumption of the display apparatus may be reduced.

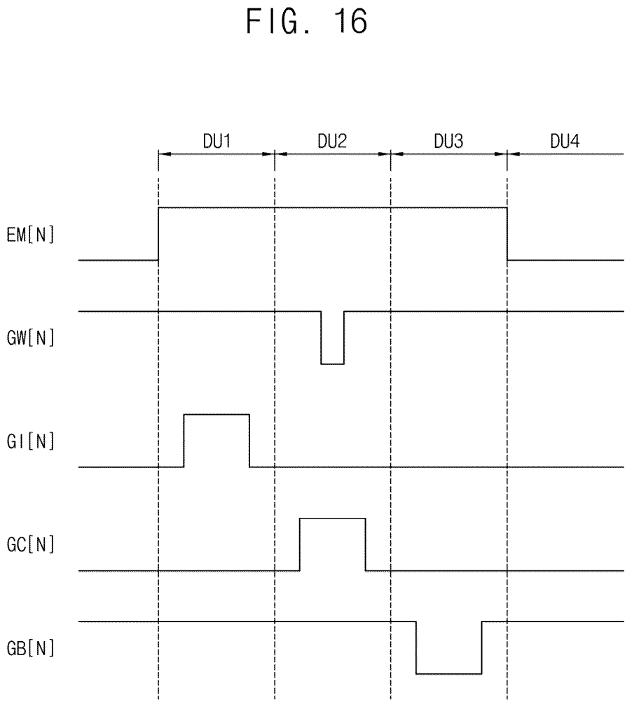

FIG. 17 is a circuit diagram illustrating an odd-numbered stage STGO′ of a driver of a display apparatus according to an embodiment of the disclosure.

A stage STGO′ of FIG. 17 may be substantially the same as the stage STGO of FIG. 4 except that the second high power voltage VGH is applied to the first electrode of the capacitor CHO of the carry output circuit COO'. Thus, redundant explanations will be omitted.

Referring to FIGS. 1 to 3, 6 and 17, the carry output circuit COO′ of the odd-numbered stage STGO′ may include a third transistor TO3 including a control electrode connected to the first control node AO, a first electrode receiving the first high power voltage SVGH and a second electrode connected to a carry output node and a fourth transistor TO4 including a control electrode connected to the first control node AO, a first electrode receiving the low power voltage VGL and a second electrode connected to the carry output node.

In the embodiment, the carry output circuit COO′ of the odd-numbered stage STGO′ may further include a capacitor CHO including a first electrode receiving the second high power voltage VGH and a second electrode connected to the first control node AO.

Although not shown in figures, a carry output circuit COE′ of an even-numbered stage STGE′ may have a structure substantially the same as the carry output circuit COO′ of the odd-numbered stage STGO'.

According to the embodiment, the driver may include the level shifter LSO and/or LSE so that the first and second clock signals CLK1 and CLK2 and the carry signals CR[N−1], CR[N] and CR[N+1] may swing (or oscillate) between the first high power voltage SVGH and the low power voltage VGL and the output signals OUT[N] and OUT[N+1] may swing (or oscillate) between the second high power voltage VGH, which is higher than the first high power voltage SVGH, and the low power voltage VGL.

The swing range of the first and second clock signals CLK1 and CLK2 and the carry signals CR[N−1], CR[N] and CR[N+1] of the driver may be reduced so that the power consumption of the display apparatus may be reduced.

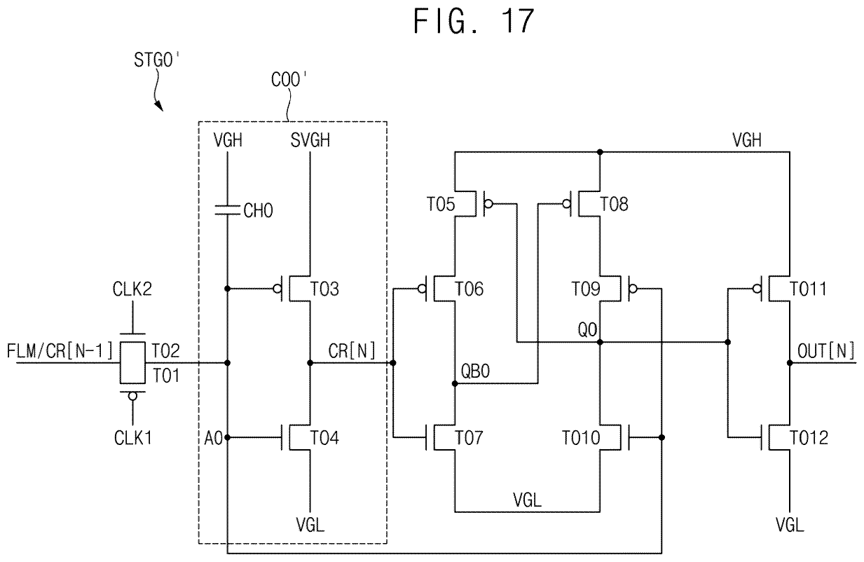

FIG. 18 is a circuit diagram illustrating an odd-numbered stage STGO″ of a driver of a display apparatus according to an embodiment of the disclosure.

A stage STGO″ of FIG. 18 may be substantially the same as the stage STGO of FIG. 4 except that the low power voltage VGL is applied to the first electrode of the capacitor CHO of the carry output circuit COO″. Thus, redundant explanations will be omitted.

Referring to FIGS. 1 to 3, 6 and 18, the carry output circuit COO″ of the odd-numbered stage STGO″ may include a third transistor TO3 including a control electrode connected to the first control node AO, a first electrode receiving the first high power voltage SVGH and a second electrode connected to a carry output node and a fourth transistor TO4 including a control electrode connected to the first control node AO, a first electrode receiving the low power voltage VGL and a second electrode connected to the carry output node.

In the embodiment, the carry output circuit of the odd-numbered stage STGO″ may further include a capacitor CHO including a first electrode receiving the low power voltage VGL and a second electrode connected to the first control node AO.

Although not shown in figures, a carry output circuit COE″ of an even-numbered stage STGE″ may have a structure substantially the same as the carry output circuit COO″ of the odd-numbered stage STGO″.

According to the embodiment, the driver may include the level shifter LSO and/or LSE so that the first and second clock signals CLK1 and CLK2 and the carry signals CR[N−1], CR[N] and CR[N+1] may swing (or oscillate) between the first high power voltage SVGH and the low power voltage VGL and the output signals OUT[N] and OUT[N+1] may swing (or oscillate) between the second high power voltage VGH, which is higher than the first high power voltage SVGH, and the low power voltage VGL.

The swing range of the first and second clock signals CLK1 and CLK2 and the carry signals CR[N−1], CR[N] and CR[N+1] of the driver may be reduced so that the power consumption of the display apparatus may be reduced.

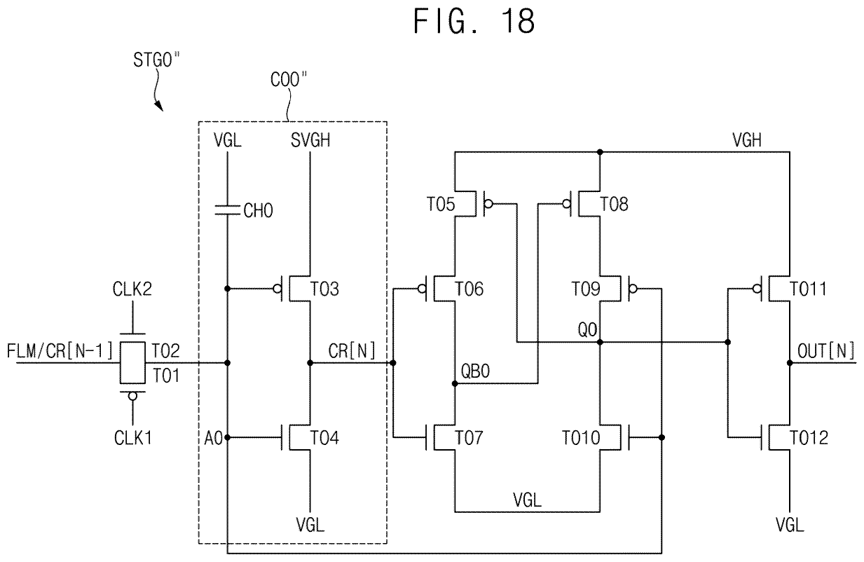

FIG. 19 is a circuit diagram illustrating an odd-numbered stage STGO′″ of a driver of a display apparatus according to an embodiment of the disclosure.

A stage STGO′″ of FIG. 19 may be substantially the same as the stage STGO of FIG. 4 except that the carry output circuit COO′″ does not include the capacitor CHO. Thus, redundant explanations will be omitted.

Referring to FIGS. 1 to 3, 6 and 19, the carry output circuit COO′″ of the odd-numbered stage STGO′″ may include a third transistor TO3 including a control electrode connected to the first control node AO, a first electrode receiving the first high power voltage SVGH and a second electrode connected to a carry output node and a fourth transistor TO4 including a control electrode connected to the first control node AO, a first electrode receiving the low power voltage VGL and a second electrode connected to the carry output node.

In the embodiment, the carry output circuit COO′″ of the odd-numbered stage STGO′″ may not include a capacitor connected to the first control node AO.

Although not shown in figures, a carry output circuit COE′″ of an even-numbered stage STGE′″ may have a structure substantially the same as the carry output circuit COO′″ of the odd-numbered stage STGO′″.

According to the embodiment, the driver may include the level shifter LSO and/or LSE so that the first and second clock signals CLK1 and CLK2 and the carry signals CR[N−1], CR[N] and CR[N+1] may swing (or oscillate) between the first high power voltage SVGH and the low power voltage VGL and the output signals OUT[N] and OUT[N+1] may swing (or oscillate) between the second high power voltage VGH, which is higher than the first high power voltage SVGH, and the low power voltage VGL.

The swing range of the first and second clock signals CLK1 and CLK2 and the carry signals CR[N−1], CR[N] and CR[N+1] of the driver may be reduced so that the power consumption of the display apparatus may be reduced.

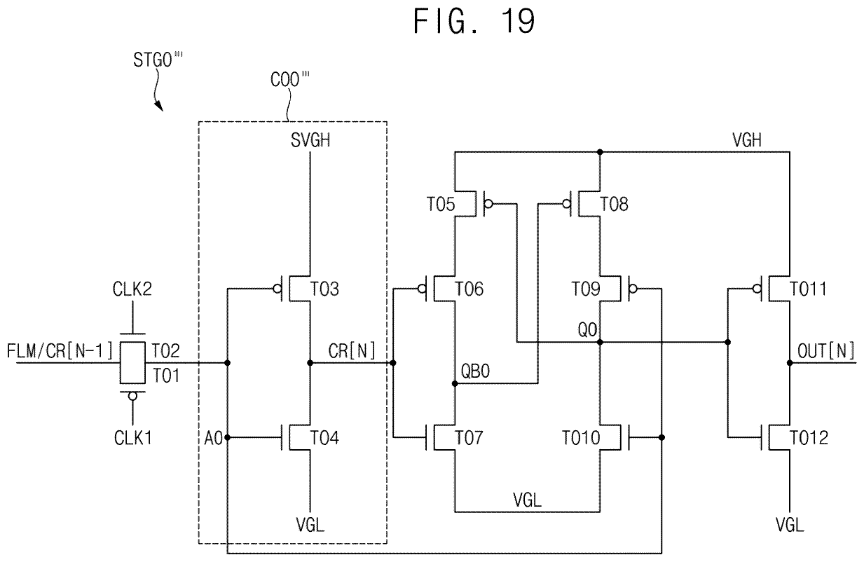

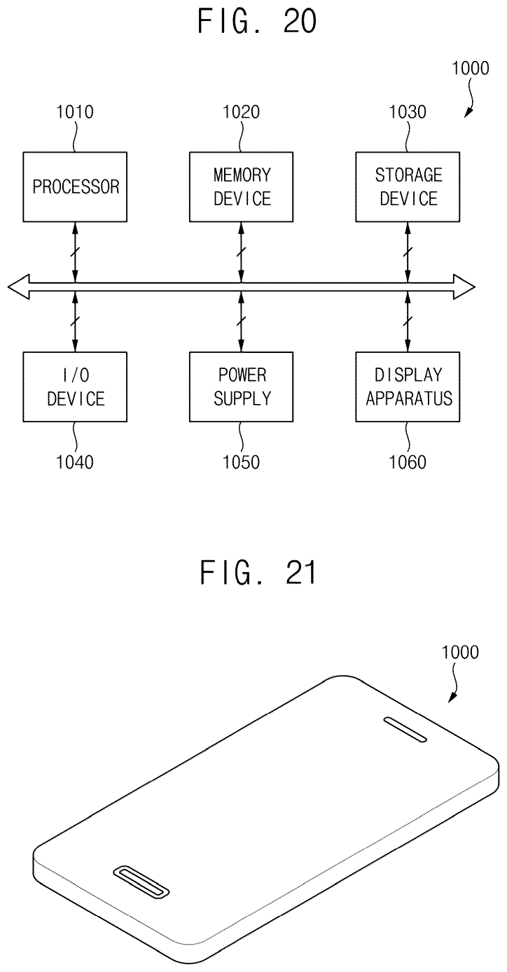

FIG. 20 is a block diagram illustrating an electronic apparatus 1000 according to an embodiment of the disclosure. FIG. 21 is a diagram illustrating an example in which the electronic apparatus 1000 of FIG. 20 is implemented as a smartphone.

Referring to FIGS. 1 to 21, the electronic apparatus 1000 may include a processor 1010, a memory device 1020, a storage device 1030, an input/output (I/O) device 1040, a power supply 1050 and a display apparatus 1060. For example, the display apparatus 1060 may be the display apparatus of FIG. 1. For example, the electronic apparatus 1000 may further include a plurality of ports for communicating with a video card, a sound card, a memory card, a universal serial bus (USB) device, other electronic apparatuses, etc.

In an embodiment, as illustrated in FIG. 21, the electronic apparatus 1000 may be implemented as a smartphone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

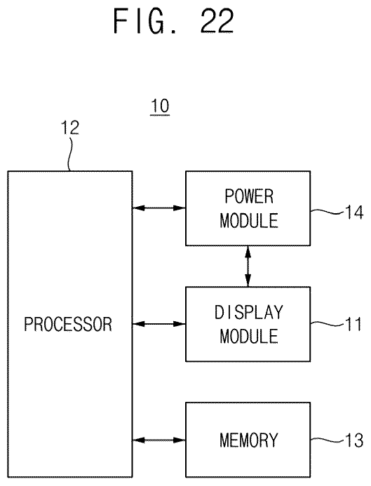

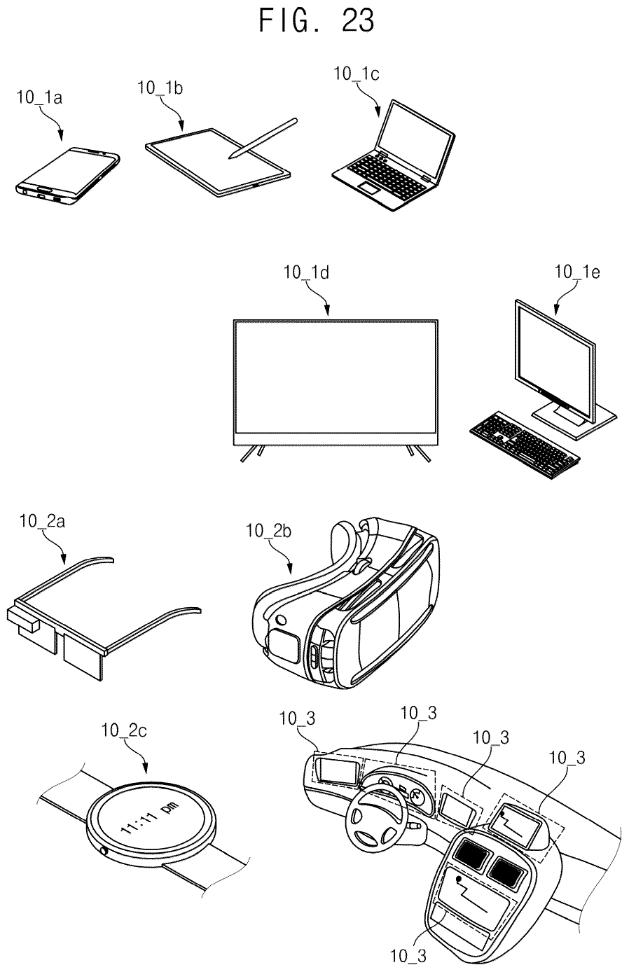

FIG. 22 is a block diagram illustrating an electronic apparatus 10 according to an embodiment of the disclosure. FIG. 23 is schematic diagrams illustrating the electronic apparatuses of FIG. 22.

Referring to FIG. 22, the electronic apparatus 10 according to an embodiment may include a display module 11, a processor 12, a memory 13 and a power module 14.

The display apparatus according to the embodiment of the disclosure may be applied to various electronic apparatuses.

In an embodiment, the electronic apparatus 10 may include the display apparatus of FIG. 1. An operation of the display apparatus included in the electronic apparatus 10 may be the same as the operation of the display apparatus explained referring to FIGS. 1 to 19. The electronic apparatus 10 may further include a module or an apparatus having additional functions in addition to the display apparatus.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display apparatus of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display apparatus of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic apparatus 10.

At least one of the elements of the electronic apparatus 10 may be included in the display apparatus according to embodiments of the disclosure. For example, a part of a single functional module may be included in the display apparatus and another part of the single functional module may be disposed out of the display apparatus. For example, the display module 11 may be included in the display apparatus but the processor 12, the memory 13 and the power module 14 may be included in another apparatus in the electronic apparatus 10 which is not the display apparatus.

Referring to FIG. 23, the various electronic apparatuses including the display apparatus according to the embodiments may include electronic apparatuses for displaying image such as a smartphone 10_1a, a tablet PC 10_1b, a laptop 10_1c, a television 10_1d, a desktop monitor 10_1e, wearable electronic apparatuses including a display module such as smart glasses 10_2a, a head mounted display 10_2b and a smart watch 10_2c and vehicle electronic apparatuses 10_3 including display modules such as a CID (center information display), a room mirror display disposed on an instrument panel, center fascia, and a dashboard of a vehicle. The electronic apparatus 10 may not be limited to the electronic apparatuses for displaying image, the wearable electronic apparatuses and the vehicle electronic apparatuses 10_3.

According to the driver, the display apparatus including the driver and the electronic apparatus including the driver of the embodiment as explained above, the power consumption of the display apparatus may be reduced.

At least one of the components, elements, modules or units (collectively “components” in this paragraph) represented by a block or an equivalent indication in the drawings including FIG. 1 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in a storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

The foregoing is illustrative of the disclosure and is not to be construed as limiting thereof. Although a few example embodiments of the disclosure have been described, those skilled in the art will readily appreciate that many modifications are possible in the example embodiments without materially departing from the novel teachings and advantages of the disclosure. Accordingly, all such modifications are intended to be included within the scope of the disclosure as defined in the claims. In the claims, means-plus-function clauses are intended to cover the structures described herein as performing the recited function and not only structural equivalents but also equivalent structures. Therefore, it is to be understood that the foregoing is illustrative of the disclosure and is not to be construed as limited to the specific example embodiments disclosed, and that modifications to the disclosed example embodiments, as well as other example embodiments, are intended to be included within the scope of the appended claims. The disclosure is defined by the following claims, with equivalents of the claims to be included therein.

What is claimed is:

1. A driver comprising a stage which comprises:
an input circuit configured to transmit a previous carry signal to a first control node in response to a first clock signal and a second clock signal having a phase different from a phase of the first clock signal;
a carry output circuit configured to generate a present carry signal based on a first high power voltage and a low power voltage in response to a signal of the first control node;
a level shifter configured to generate a signal of a second control node and a signal of a third control node in response to a second high power voltage, which is greater than the first high power voltage, and the low power voltage; and
an output circuit configured to generate an output signal based on the second high power voltage and the low power voltage in response to the signal of the second control node or the signal of the third control node.

2. The driver of claim 1, wherein the driver comprises a plurality of the stages comprising at least one odd-numbered stage and at least one even-numbered stage connected in series,
wherein, based on the stage being an odd-numbered stage among the plurality of the stages connected in series, the output circuit is configured to output the output signal in response to the signal of the second control node, and
wherein, based on the stage being an even-numbered stage, the output circuit is configured to output the output signal in response to the signal of the third control node.

3. The driver of claim 2, wherein, based on the stage being the odd-numbered stage, a phase of the present carry signal is opposite to a phase of the output signal, and
wherein, based on the stage being the even-numbered stage, a phase of the present carry signal is substantially the same as a phase of the output signal.

4. The driver of claim 2, wherein, based on the stage being the odd-numbered stage, a phase of the signal of the first control node is substantially the same as the phase of the output signal, and
wherein, based on the stage being the even-numbered stage, a phase of the signal of the first control node is opposite to the phase of the output signal.

5. The driver of claim 1, wherein each of a high level of the previous carry signal, a high level of the present carry signal, a high level of the first clock signal, and a high level of the second clock signal is the first high power voltage,
wherein each of a low level of the previous carry signal, a low level of the present carry signal, a low level of the first clock signal, and a low level of the second clock signal is the low power voltage,
wherein a high level of the output signal is the second high power voltage, and
wherein a low level of the output signal is the low power voltage.

6. The driver of claim 5, wherein a high level of the signal of the first control node is the first high power voltage, and
wherein a low level of the signal of the first control node is the low power voltage.

7. The driver of claim 5, wherein each of a high level of the signal of the second control node and a high level of the signal of the third control node is the second high power voltage, and
wherein each of a low level of the signal of the second control node and a low level of the signal of the third control node is the low power voltage.

8. The driver of claim 1, wherein the input circuit comprises:
a first transistor comprising a control electrode configured to receive the first clock signal, a first electrode configured to receive the previous carry signal, and a second electrode connected to the first control node; and
a second transistor comprising a control electrode configured to receive the second clock signal, a first electrode configured to receive the previous carry signal, and a second electrode connected to the first control node.

9. The driver of claim 1, wherein the carry output circuit comprises:
a first transistor comprising a control electrode connected to the first control node, a first electrode configured to receive the first high power voltage and a second electrode connected to a carry output node; and
a second transistor comprising a control electrode connected to the first control node, a first electrode configured to receive the low power voltage and a second electrode connected to the carry output node.

10. The driver of claim 9, wherein the carry output circuit further comprises:
a capacitor comprising a first electrode configured to receive the first high power voltage and a second electrode connected to the first control node.

11. The driver of claim 9, wherein the carry output circuit further comprises:
a capacitor comprising a first electrode configured to receive the second high power voltage and a second electrode connected to the first control node.

12. The driver of claim 1, wherein the level shifter comprises:
a first transistor comprising a control electrode connected to the second control node, a first electrode configured to receive the second high power voltage and a second electrode connected to a first intermediate node;
a second transistor comprising a control electrode connected to the carry output node, a first electrode connected to the first intermediate node and a second electrode connected to the third control node;
a third transistor comprising a control electrode connected to the carry output node, a first electrode configured to receive the low power voltage and a second electrode connected to the third control node;
a fourth transistor comprising a control electrode connected to the third control node, a first electrode configured to receive the second high power voltage and a second electrode connected to a second intermediate node;
a fifth transistor comprising a control electrode connected to the first control node, a first electrode connected to the second intermediate node and a second electrode connected to the second control node; and
a sixth transistor comprising a control electrode connected to the first control node, a first electrode configured to receive the low power voltage and a second electrode connected to the second control node.

13. The driver of claim 12, wherein the output circuit comprises:
a seventh transistor comprising a control electrode connected to the second control node, a first electrode configured to receive the second high power voltage and a second electrode connected to an output node; and
an eighth transistor comprising a control electrode connected to the second control node, a first electrode configured to receive the low power voltage and a second electrode connected to the output node.

14. The driver of claim 12, wherein the output circuit comprises:
a seventh transistor comprising a control electrode connected to the third control node, a first electrode configured to receive the second high power voltage and a second electrode connected to an output node; and
an eighth transistor comprising a control electrode connected to the third control node, a first electrode configured to receive the low power voltage and a second electrode connected to the output node.

15. The driver of claim 1, wherein, based on the stage being an odd-numbered stage, the odd-numbered stage comprises:
a first transistor comprising a control electrode configured to receive the first clock signal, a first electrode configured to receive the previous carry signal and a second electrode connected to the first control node;
a second transistor comprising a control electrode configured to receive the second clock signal, a first electrode configured to receive the previous carry signal and a second electrode connected to the first control node;
a third transistor comprising a control electrode connected to the first control node, a first electrode configured to receive the first high power voltage and a second electrode connected to a carry output node;
a fourth transistor comprising a control electrode connected to the first control node, a first electrode configured to receive the low power voltage and a second electrode connected to the carry output node;
a fifth transistor comprising a control electrode connected to the second control node, a first electrode configured to receive the second high power voltage and a second electrode connected to a first intermediate node;
a sixth transistor comprising a control electrode connected to the carry output node, a first electrode connected to the first intermediate node and a second electrode connected to the third control node;
a seventh transistor comprising a control electrode connected to the carry output node, a first electrode configured to receive the low power voltage and a second electrode connected to the third control node;
an eighth transistor comprising a control electrode connected to the third control node, a first electrode configured to receive the second high power voltage and a second electrode connected to a second intermediate node;
a ninth transistor comprising a control electrode connected to the first control node, a first electrode connected to the second intermediate node and a second electrode connected to the second control node;
a tenth transistor comprising a control electrode connected to the first control node, a first electrode configured to receive the low power voltage and a second electrode connected to the second control node;
an eleventh transistor comprising a control electrode connected to the second control node, a first electrode configured to receive the second high power voltage and a second electrode connected to an output node; and
a twelfth transistor comprising a control electrode connected to the second control node, a first electrode configured to receive the low power voltage and a second electrode connected to the output node,
wherein the first transistor, the third transistor, the fifth transistor, the sixth transistor, the eighth transistor, the ninth transistor and the eleventh transistor of the odd-numbered stage are P-type transistors, respectively, and
wherein the second transistor, the fourth transistor, the seventh transistor, the tenth transistor and the twelfth transistor of the odd-numbered stage are N-type transistors, respectively.

16. The driver of claim 15, wherein, based on the stage being an even-numbered stage, the even-numbered stage comprises:
a first transistor comprising a control electrode configured to receive the second clock signal, a first electrode configured to receive the previous carry signal and a second electrode connected to the first control node;
a second transistor comprising a control electrode configured to receive the first clock signal, a first electrode configured to receive the previous carry signal and a second electrode connected to the first control node;
a third transistor comprising a control electrode connected to the first control node, a first electrode configured to receive the first high power voltage and a second electrode connected to a carry output node;
a fourth transistor comprising a control electrode connected to the first control node, a first electrode configured to receive the low power voltage and a second electrode connected to the carry output node;
a fifth transistor comprising a control electrode connected to the second control node, a first electrode configured to receive the second high power voltage and a second electrode connected to a first intermediate node;
a sixth transistor comprising a control electrode connected to the carry output node, a first electrode connected to the first intermediate node and a second electrode connected to the third control node;
a seventh transistor comprising a control electrode connected to the carry output node, a first electrode configured to receive the low power voltage and a second electrode connected to the third control node;
an eighth transistor comprising a control electrode connected to the third control node, a first electrode configured to receive the second high power voltage and a second electrode connected to a second intermediate node;
a ninth transistor comprising a control electrode connected to the first control node, a first electrode connected to the second intermediate node and a second electrode connected to the second control node;
a tenth transistor comprising a control electrode connected to the first control node, a first electrode configured to receive the low power voltage and a second electrode connected to the second control node;
an eleventh transistor comprising a control electrode connected to the third control node, a first electrode configured to receive the second high power voltage and a second electrode connected to an output node; and
a twelfth transistor comprising a control electrode connected to the third control node, a first electrode configured to receive the low power voltage and a second electrode connected to the output node,
wherein the first transistor, the third transistor, the fifth transistor, the sixth transistor, the eighth transistor, the ninth transistor and the eleventh transistor of the even-numbered stage are P-type transistors, respectively, and
wherein the second transistor, the fourth transistor, the seventh transistor, the tenth transistor and the twelfth transistor of the even-numbered stage are N-type transistors, respectively.

17. A display apparatus comprising:
a display panel comprising a pixel;
a gate driver configured to output a gate signal to the pixel;
a data driver configured to output a data voltage to the pixel; and
an emission driver configured to output an emission signal to the pixel,
wherein at least one of the gate driver and the emission driver comprises the stage of claim 1.

18. An electronic apparatus comprising:
a display panel comprising a pixel;
a gate driver configured to output a gate signal to the pixel;
a data driver configured to output a data voltage to the pixel;
an emission driver configured to output an emission signal to the pixel;
a driving controller configured to control the gate driver, the data driver and the emission driver; and
a processor configured to output input image data and an input control signal to the driving controller,
wherein at least one of the gate driver and the emission driver comprises the stage of

1.

19. A driver comprising:
a first stage and a second stage connected in series, each of the first and second stages comprising:
an input circuit configured to transmit a previous carry signal to a first control node in response to a clock signal;
a carry output circuit configured to generate a present carry signal based on a first high power voltage and a low power voltage in response to a signal of the first control node;
a level shifter configured to generate a signal of a second control node and a signal of a third control node in response to a second high power voltage, which is greater than the first high power voltage, and the low power voltage; and
an output circuit configured to generate an output signal based on the second high power voltage and the low power voltage,
wherein the output circuit of the first stage is configured to generate the output signal in response to the signal of the second control node,
wherein the input circuit of the second stage is configured to receive the present carry signal of the first stage, and
wherein the output circuit of the second stage is configured to generate the output signal in response to the signal of the third control node.

20. A driver comprising:
an input circuit configured to transmit an input carry signal to a first control node in response to a clock signal;
a carry output circuit configured to generate an output carry signal based on a first high power voltage and a low power voltage in response to a signal of the first control node such that the output carry signal has a first swing range between the first high power voltage and the low power voltage;
a level shifter configured to generate a signal of a second control node and a signal of a third control node in response to a second high power voltage, which is greater than the first high power voltage, and the low power voltage, such that the signal of the second control node and the signal of the third control node each have a second swing range between the first high power voltage and the low power voltage, the second swing range being greater than the first swing range; and
an output circuit configured to generate an output signal based on the second high power voltage and the low power voltage in response to the signal of the second control node or the signal of the third control node such that the output signal has the second swing range.
